(19) United States
(12) Patent Application Publication
(10) Pub. No.: US 2025/0086399 A1
(43) Pub. Date: Mar. 13, 2025

(54) SMART TOWING ASSISTANT

(71) Applicant: State Farm Mutual Automobile Insurance Company, Bloomington, IL (US)

(72) Inventor: Brian N. Harvey, Bloomington, IL (US)

(21) Appl. No.: 18/827,404

(22) Filed: Sep. 6, 2024

Related U.S. Application Data
(60) Provisional application No. 63/582,322, filed on Sep. 13, 2023.
(60) Provisional application No. 63/584,789, filed on Sep. 22, 2023.
(60) Provisional application No. 63/589,455, filed on Oct. 11, 2023.
(60) Provisional application No. 63/600,499, filed on Nov. 17, 2023.
(60) Provisional application No. 63/613,630, filed on Dec. 21, 2023.

(51) Int. Cl. G06F 40/35; G06F 40/279; G06F 40/40; G06Q 40/08; G06V 20/58

(52) U.S. Cl. CPC G06F 40/35; G06F 40/279; G06F 40/40; G06Q 40/08; G06V 20/58

(57) ABSTRACT

A smart towing assistant provides towing-related information to a user associated with towing of a towable object by a vehicle. A chatbot of the smart towing assistant engages in a conversation with the user to answer towing-related questions and provide towing-related information, including towing-related safety information, steering and driving information, and information related to towing insurance. The smart towing assistant may also detect instances of towing activity, and corresponding towing usage information can be used to determine billing amounts associated with usage-based towing insurance. The smart towing assistant may also provide lane assist detection associated with towing of a towable object by a vehicle, to alert a driver of detected towing-related safety issues.

### PRIORITY

This U.S. Patent Application claims priority to U.S. Provisional Patent Application No. 63/582,322, filed on Sep. 13, 2023 and entitled “SMART TOWING ASSISTANT,” U.S. Provisional Patent Application No. 63/584,789, filed on Sep. 22, 2023 and entitled “SMART TOWING ASSISTANT,” U.S. Provisional Patent Application No. 63/589,455, filed on Oct. 11, 2023 and entitled “SMART TOWING ASSISTANT,” U.S. Provisional Patent Application No. 63/600,499, filed on Nov. 17, 2023 and entitled “SMART TOWING ASSISTANT,” and U.S. Provisional Patent Application No. 63/613,630, filed on Dec. 21, 2023 and entitled “SMART TOWING ASSISTANT,” the disclosures of which are incorporated herein by reference in their entirety.

### TECHNICAL FIELD

The present disclosure relates to towing of a towable object by a vehicle, particularly with respect to a smart towing assistant configured to provide towing-related information to a user in association with towing of the towable object by a vehicle.

### BACKGROUND

Vehicles, such as trucks or cars, may tow other objects when such objects are attached to hitches or other connectors of the vehicles. For example, towable objects such as a trailer, camper, boat, or other object may be attached to a truck so that the truck can tow the towable object.

However, in some situations, a driver or other user associated with a vehicle may have limited experience with towing objects. The driver or other user may accordingly be unsure how to safely attach a towable object to the vehicle, be unsure how to safely drive while towing the towable object, and/or be unsure about other aspects of towing the towable object. The driver or other user may also be unsure whether insurance coverage is in place to cover towing the towable object with the vehicle.

The exemplary computer systems and computer-implemented methods described herein may be directed toward mitigating or overcoming one or more of the deficiencies described above. Conventional techniques may have additional drawbacks, inefficiencies, ineffectiveness, and/or encumbrances as well.

### BRIEF SUMMARY

Described herein are systems and methods by which a smart towing assistant, executed via a dashboard system of a vehicle, via a user device, and/or via other computing systems, may provide, inter alia, towing-related information to a user before and/or during towing of a towable object by a vehicle. The smart towing assistant may include a chatbot (or voice bot) that the user can interact with to ask towing-related questions and/or receive towing-related information. As example, the chatbot may provide the user with safety tips, checklists, and/or other information that helps the user to safely tow the towable object with the vehicle. As another example, the chatbot may provide the user with information indicating that the user does or does not have insurance coverage that covers towing of the towable object with the vehicle. The chatbot may also provide insurance quotes and/or bind changes to an insurance policy, for instance to add or adjust towing insurance coverage to the user's insurance policy. If the user has usage-based towing insurance, the smart towing assistant may detect when the vehicle is being used to tow objects, and may generate or provide towing usage data such that the user can be billed for detected towing activities in association with the usage-based towing insurance. The smart towing assistant may also provide lane assist detection associated with towing of a towable object by a vehicle, such that the smart towing assistant may alert a driver of the vehicle if the towable object is veering into a different lane and/or is at risk of impacting another vehicle or object during a lane change or a turn.

According to a first aspect, a computer-implemented method for providing towing-related information, towing-related assistance, and/or a smart towing assistant may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may include (1) providing, by a computing system including one or more local or remote processors, a smart towing assistant. The smart towing assistant may be trained, based upon a training dataset, to engage in a conversation with a user in association with towing of a towable object by a vehicle. The computer-implemented method may also include (2) receiving, by the computing system, and/or via the chatbot during the conversation, user input. The user input may include, for example, natural language input. The computer-implemented method additionally may include (3) generating, by the computing system, and/or via the chatbot, output based at least in part on the user input. The output may include, for instance, natural language output that expresses towing-related information. The computer-implemented method may also include (4) presenting, by the computing system, and/or via the chatbot, the output during the conversation. The method may include additional, less, or alternate functionality and actions, including those discussed elsewhere herein.

According to a second aspect, a computing system may provide a smart towing assistant, or otherwise provide towing-related assistance and/or information. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer system may include one or more local or remote processors, and memory storing computer-executable instructions to (1) provide the smart towing assistant. The computer-executable instructions, when executed by the one or more processors, cause the one or more processors to (2) receive, via a chatbot trained on a training dataset, and during a conversation association with towing of a towable object by a vehicle, user input including, for example, natural language input. The computer-executable instructions may also cause the one or more processors to (3) generate, via the chatbot, output based at least in part on the user input. The output includes, for example, natural language output that expresses towing-related information. The computer-executable instructions further may cause the one or more processors to (4) present, via the chatbot, the output during the conversation. The computer system may include additional, less, or alternate functionality, including that discussed elsewhere herein.

According to a third aspect, a computer-implemented smart towing assistant may include a chatbot, a towing detector, and/or a towing lane assist system. The chatbot may be trained, based upon a training dataset, to engage in a conversation with a user in association with towing of a towable object by a vehicle. The towing detector may be configured to detect, based upon sensor data associated with at least one of the vehicle or the towable object, towing activity associated with the towing of the towable object by the vehicle. The towing lane assist system may be configured to detect, based upon the sensor data, a safety issue associated with the towing of the towable object by the vehicle, and to output an alert associated with the safety issue. The smart towing assistant may include additional, less, or alternate functionality, including that discussed elsewhere herein.

According to a fourth aspect, a system may include a sensor mounted on a towable object towed by a vehicle, and a computer-executable towing lane assist system. The computer-executable towing lane assist system may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-executable towing lane assist system may be configured to (1) receive sensor data captured by the sensor. The computer-executable towing lane assist system may also be configured to (2) determine, based upon the sensor data, a position of the towable object relative to an element in an environment surrounding the towable object; and/or (3) detect, based upon the position of the towable object relative to the element, a safety issue associated with towing of the towable object by the vehicle. The computer-executable towing lane assist system may also be configured to (4) output a safety alert configured to inform a driver of the vehicle of the safety issue. The computer-executable towing lane assist system may be configured to execute additional, less, or alternate functionality and actions, including those discussed elsewhere herein.

According to a fifth aspect, a computer-implemented method may include providing a towing lane assist system or otherwise providing towing-related assistance and/or information. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer-implemented method may include (1) receiving, by a computing system comprising one or more processors, sensor data captured by at least one sensor mounted on a towable object being towed by a vehicle. The computer-implemented method may also include (2) determining, by the computing system, and based upon the sensor data, a position of the towable object relative to an element in an environment surrounding the towable object; and/or (3) detecting, by the computing system, and based upon the position of the towable object relative to the element, a safety issue associated with towing of the towable object by the vehicle. The computer-implemented method may also include (4) outputting, by the computing system, a safety alert configured to inform a driver of the vehicle of the safety issue. The computer-implemented method may include additional, less, or alternate functionality and actions, including those discussed elsewhere herein.

According to a sixth aspect, one or more non-transitory computer-readable media store computer-executable instructions associated with a towing lane assist system that may be executed by one or more processors of a computing system. The computing system may include one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another. For example, in one instance, the computer-executable instructions may cause the one or more processors to: (1) receive sensor data captured by at least one sensor mounted on a towable object being towed by a vehicle. The computer-executable instructions may also cause the one or more processors to (2) determine, based upon the sensor data, a position of the towable object relative to an element in an environment surrounding the towable object. The computer-executable instructions may additionally cause the one or more processors to (3) detect, based upon the position of the towable object relative to the element, a safety issue associated with towing of the towable object by the vehicle. The computer-executable instructions may also cause the one or more processors to (4) output a safety alert configured to inform a driver of the vehicle of the safety issue. The computer-executable instructions may cause include additional, less, or alternate functionality, including that discussed elsewhere herein.

According to a seventh aspect, a computer-implemented method may include providing a smart towing assistant or otherwise providing towing-related assistance and/or information. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computer-implemented method may include (1) receiving, by a computing system comprising a processor, sensor data. The sensor data may be captured by at least one sensor in association with a maneuver performed by a vehicle during towing of a towable object by the vehicle. The at least one sensor may be mounted on the vehicle or the towable object. The computer-implemented method may also include (2) detecting, by the computing system, and based at least in part on the sensor data, a safety issue associated with the maneuver; and/or (3) generating, by the computing system, output (such as an alert, visual, graphic, audible, and/or verbal output, or combination output thereof) configured to alert a driver of the vehicle of the safety issue. The computer-implemented method may include additional, less, or alternate functionality and actions, including those discussed elsewhere herein.

According to an eighth aspect, a computer system may include a sensor mounted on a towable object towed by a vehicle, and a computer-executable smart towing assistant system. The computer-executable smart towing assistant may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-executable smart towing assistant may be configured to (1) receive sensor data, captured by the sensor, in association with a maneuver performed by the vehicle during towing of the towable object; (2) detect, based at least in part on the sensor data, a safety issue associated with the maneuver; and/or (3) generate output configured to alert a driver of the vehicle of the safety issue. The computer-executable smart towing assistant may be configured to execute additional, less, or alternate functionality and actions, including those discussed elsewhere herein.

According to a ninth aspect, one or more non-transitory computer-readable media store computer-executable instructions associated with a smart towing assistant that may be executed by one or more processors of a computing system. The computing system may include one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another. For example, in one instance, the computer-executable instructions may cause the one or more processors to: (1) receive sensor data, captured by at least one sensor, in association with a maneuver performed by a vehicle during towing of a towable object by the vehicle. The computer-executable instructions may also cause the one or more processors to (2) detect, based at least in part on the sensor data, a safety issue associated with the maneuver; and/or (3) generate output configured to alert a driver of the vehicle of the safety issue. The computer-executable instructions may cause include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 depicts an exemplary computing environment in which a smart towing assistant may provide a user with information relevant to using a vehicle to tow a towable object.

FIG. 2 depicts a flowchart illustrating an exemplary computer-implemented method for training and using a chatbot associated with the smart towing assistant.

FIG. 3 depicts a flowchart illustrating an exemplary computer-implemented method for implementing usage-based towing insurance coverage based upon sensor data.

FIG. 4 depicts a flowchart illustrating an exemplary computer-implemented method for providing alerts to a driver of a vehicle when sensor data indicates a safety issue associated with towing of the towable object by the vehicle.

FIG. 5 depicts an exemplary computer system architecture for a computing system that may execute one or more elements associated with the smart towing assistant, the model training system, the Usage-Based Insurance (UBI) system, and/or other elements described herein.

FIG. 6 depicts an exemplary computer-implemented method of providing driving assistance and/or instructions while towing a towable.

FIG. 7 shows an exemplary environment in which a towing lane assist system can alert a driver of a vehicle regarding towing-related safety issues while the vehicle is towing a towable object.

FIG. 8 shows a flowchart illustrating an exemplary computer-implemented method for providing alerts to a driver of a vehicle when sensor data indicates a safety issue associated with towing of a towable object by the vehicle.

FIG. 9 shows an exemplary computing environment in which the smart towing assistant may assist a driver of the vehicle in association with turning and/or cornering maneuvers while the vehicle is towing the towable object.

FIG. 10 shows an exemplary computing environment in which the smart towing assistant may assist a driver of the vehicle in association with backup maneuvers while the vehicle is towing the towable object.

The detailed description is set forth with reference to the accompanying figures. In the figures, the left-most digit(s) of a reference number identifies the figure in which the reference number first appears. The use of the same reference numbers in different figures indicates similar or identical items or features.

### DETAILED DESCRIPTION

Computer systems and computer-implemented methods are described herein by which a smart towing assistant, executed via a dashboard system of a vehicle, via a user device, and/or via other computing systems, may provide, inter alia, towing-related information to a user before and/or during towing of a towable object by a vehicle. The smart towing assistant may include a chatbot (or voice bot) that the user can interact with to ask towing-related questions and/or receive towing-related information.

### Exemplary Towing Lane Assist

When towing a trailer, boat, camper, etc. it may be difficult to safely change lanes in traffic because the driver may not be able to judge the distance in front of another vehicle properly. Blind spots may also cause difficulty in safely changing lanes when towing. Additionally, it may be difficult to make a right turn in some circumstances and a towable may hit something if the turn is not performed correctly and/or if the driver is not pay close attention. These issues may lead to collisions involving the towable and towing vehicle, or even between other vehicles as they maneuver to avoid the towable and collide with one another.

The present embodiments may provide a built-in capability or retrofit option of a computer system that uses sensors, such as a camera, on either side of a towable to detect other vehicles in the lane the driver is attempting to move into. The computer system may be trained to use the road markers to delineate where the lane boundaries are to anticipate when the driver is attempting to change lanes. If the distance between the towable and the road marker (solid or dashed lines, for example) is closing, either the driver is changing lanes or drifting. If there is a vehicle in the other lane, the system may alert the driver.

The computer system may be trained to recognize an unsafe situation when turning a corner and alert the driver that the towable is on track to collide with an external object if the turn is continued. For built in systems, if the driver turns on the blinker indicating they are going to change lanes, the system may alert if there is a vehicle in the other lane. For retro fit systems, the system may be calibrated to understand the length of the towable.

As a result, drivers may be provided a capability that adds another level of safety when they are towing. Also, as drivers become used to driving with lane assist on their vehicle, they may rely on it more than they should and become complacent. This may be an issue if the vehicle's lane assist does not take into account the towable behind it causing the system to not alert when a vehicle is in the other lane next to the towable, but not the vehicle towing.

### Chatgpt Bot for Towing Information

Policy holders may not know if they have towing coverage on their insurance policy, or what towing coverage covers and how they can be protected when towing something behind their vehicle. The insureds may have questions such as: (1) How to add Towing coverage to policy?; (2) Do I have towing on my policy (and which vehicles)?; (3) Do I need towing coverage?; and/or (4) What if I don't have towing coverage and I tow my friend's boat/camper/etc.?

Also, drivers may not know how to properly hitch a towable (camper, boat, trailer, etc.) to their vehicle or what can safely be towed behind their specific vehicle. Further, drivers may not know how to safely tow the towable they are towing based upon their specific vehicle and the size, weight, etc. of the towable. Lastly, there may be important information the driver doesn't yet have about towing due to lack of experience, such as: (i) How to inspect the lights; (ii) Safe driving speeds; (iii) How to navigate traffic; (iv) How to park with a trailer; and/or (v) How to back a trailer (with a static hitch or an articulating hitch).

The present embodiments may include a ChatGPT-based Chatbot that may interact with policy holders via a text-based conversation or a voice-based conversation. Voice-based conversations may leverage voice-to-text and text-to-voice or other technologies, such as natural language processing (NLP), to provide a natural conversation with the policy holder. The chatbot may also provide videos for the purpose of demonstrating to a policy holder how to accomplish a task.

The present embodiments may provide an effective and efficient manner for a policy holder to get information regarding towing coverage (if their policy has it, how much is it, what are the coverages, etc.). The system may also quote and bind coverage or increase limits at the policy holder's request.

During the conversation, the chatbot may steer the conversation to important safety information through a series of natural questions, comments, or even humor, to learn how much experience or knowledge the policy holder may have with towing objects behind a vehicle. As the conversation is analyzed, more appropriate information may be provided to the policy holder in the form of text, voice, or even how-to videos. For example, if the computer system determines the policy holder has never hitched or towed a boat, it may suggest things to check before towing.

These checks may include checking to ensure the boat is secured to the trailer properly, the safety chains/cables are connected, the lights (brake lights, blinkers, running lights, etc.) are working properly. A video may be provided as an effective way to convey this information. Additionally or alternatively, a checklist may be provided.

Further, the conversation may include information about safely navigating traffic. For example, making wider turns then normal, ensuring enough room when switching lanes, safely parking, etc.

One of the more difficult tasks when towing something is backing up. If the system determines the policy holder has limited experience towing, it may provide information and demonstration videos on how to safely back up a trailer. This may be helpful for experienced users as well if they are backing a towable with an articulating hitch as it is different than a static hitch.

This information may be provided by the system based upon pre-trained models. These models may determine things like, if a certain towable can be safely towed behind a specific vehicle, or at what speeds, etc. This may be answered by either typing in information about the vehicle and towable or simply submitting a picture of them. The system may be configured to recognize the vehicle and match it to the details of the policy, as well as recognize the towable and retrieve the details from a database. If the policy holder also owns the towable, the information about the towable may be included as well.

Using the system may potentially result in a discount if, through the conversation, the system determines the policy holder has enough information to reduce the risk of operating a vehicle with something in tow.

Exemplary inputs to the ML (Machine Learning) model to train the ChatGPT bot may include: (i) Vehicle towing information from automobile manufacturers; (ii) Trailer hitch connection information from manufacturers; (iii) Text and video of how to properly hitch/connect a trailer (the actual hitch, lights, safety chains/cables, emergency brake cable, etc.); (iv) general towing coverage information; (v) Past anonymized insurance claim data to help determine risk and potential discount; and/or (vi) Towable information (size, weight, pictures, etc.) from towable manufacturers (boats, campers, trailers, etc.). Additional inputs may include (a) Policy specific information; (b) Vehicle specific information; and/or (c) Towable specific information (can be a picture, text description, etc.).

There are several exemplary outputs that a driver or user may receive. The driver or user may receive information from the Towing ChatGPT bot regarding their coverage and how to safely hitch and tow the towable. This information may be given to the policy holder via the Chatbot in text or through text-to-voice and/or voice-to-text in a manner that flows naturally. For instance, if the policy holder asks if they have towing coverage, the chatbot may answer the towing coverage questions and then ask the user questions that helps the chatbot understand the user's own level of knowledge/experience with towing and may offer helpful information. A user may also receive a discount for interacting with the chatbot if they received enough information from the chatbot. The depth of the conversation may be analyzed to determine if a pre-set threshold has been met.

As a result, policy holders will gain value from this ChatGPT-based Towing chatbot by having easy access to important information regarding towing objects behind their vehicle. This information may be coverage information to help them understand how to protect themselves if they are not protected and to what level of protection they may have or need based upon the specific circumstances. It also includes safety information regarding hitching a towable and how to safely operate a towing vehicle with something in tow. These things will benefit the policy holder by reducing the risk associated with towing anything behind a vehicle and help them protect themselves when they do.

### Usage-Based Towing Coverage

Policy holders with towing coverage vary in the amount of time/miles spent actually towing a towable (trailer, boat, camper, etc.). Some insureds hardly ever tow their towable, while others may tow several times per week. The cost of a policy may not be specific to the risk presented by the individual insureds based upon when, where, and how often they are actually towing.

The present embodiments may provide towing UBI (Usage-Based Insurance). Usage-based towing coverage provides a cost savings product to policy holders that charges them for towing based upon when and how long they are towing. The computer system may include the Drive Safe and Save (DSS) module, or a similar module, that may detect when a vehicle is towing something. Billing may preferably be based upon actual towed miles, or a discount given based actual towed mileage. Other data may be incorporated as well to help determine the actual risk. For example, data may include: (1) Location data. For instance, risk may be greater in areas with more traffic; and mountainous areas with steep grades that may result in unsafe speeds. The data may include: (2) Time of day data. For instance, night towing may be more risky due to reduced visibility; and certain times of day in certain locations have a higher risk due to traffic patterns (rush hour). The data may include (3) Weather data. For instance, precipitation of any kind may increase the risk; and snow and ice create an even higher risk. Conversely, a warm sunny day may lower the risk, and a larger discount may be provided for those that drive in clear weather.

Machine learning models may be created using real-world towing data to train models based upon various vehicles and towables. Once properly trained, telemetry and accelerometers within the DSS device may be used to detect when a vehicle is towing something due to the difference in acceleration, deceleration, cornering, and even driving straight as the vehicle tends to handle differently that when not towing. These minute differences may be used to develop a towing profile for vehicles. It would even be possible to train the system to learn what a normal non-towing profile of the vehicle looks like and that can be compared to a general towing profile and/or a known towing profile for the vehicle to determine when towing is taking place.

There are several data inputs to the ML models. For instance, the ML models may be trained on collected data from vehicles towing various towables such as trailers, boats, campers, etc. In preferred embodiments, the drivers may enjoy potential cost savings on insurance based upon their actual miles towing trailers or other towables.

As example, the chatbot may provide the user with safety tips, checklists, and/or other information that helps the user to safely tow the towable object with the vehicle. As another example, the chatbot may provide the user with information indicating that the user does or does not have insurance coverage that covers towing of the towable object with the vehicle. The chatbot may also provide insurance quotes and/or bind changes to an insurance policy, for instance to add or adjust towing insurance coverage to the user's insurance policy.

If the user has usage-based towing insurance, the smart towing assistant may detect when the vehicle is being used to tow objects, and may generate or provide towing usage data such that the user can be billed for detected towing activities in association with the usage-based towing insurance. The smart towing assistant may also provide lane assist detection associated with towing of a towable object by a vehicle, such that the smart towing assistant may alert a driver of the vehicle if the towable object is veering into a different lane and/or is at risk of impacting another vehicle or object during a lane change or a turn.

### Exemplary Computing Environment

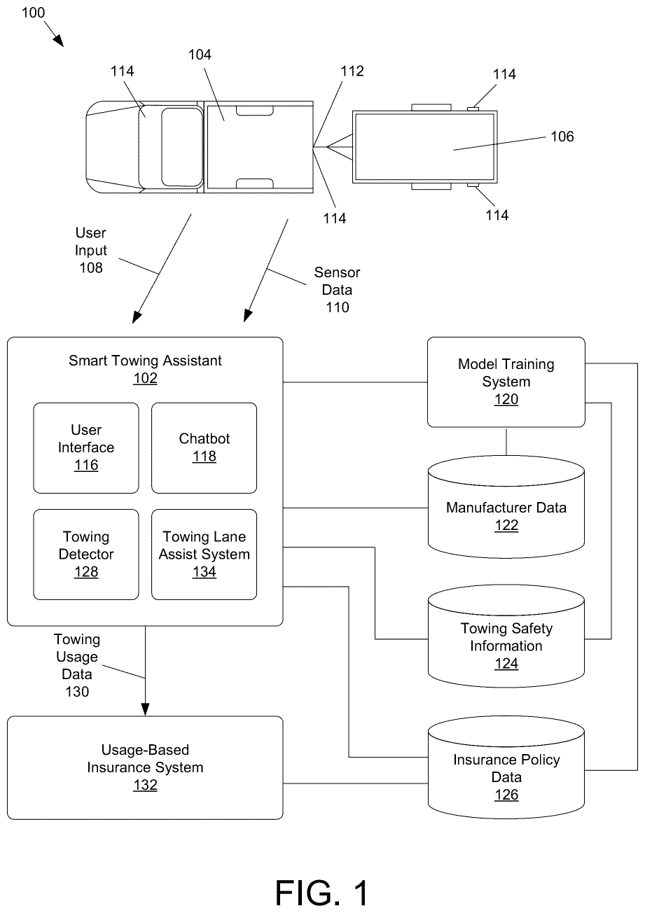

FIG. 1 shows an exemplary computing environment 100 in which a smart towing assistant 102 may provide a user with information relevant to using a vehicle 104 to tow a towable object 106. The smart towing assistant 102 may be a computer-implemented system that can receive data, such as user input 108 and/or sensor data 110, associated with towing of the towable object 106 by the vehicle 104. The smart towing assistant 102 may provide corresponding output to a user that is relevant to the towing of the towable object 106 by the vehicle 104. The output of the smart towing assistant 102 may include safety information, insurance information, driving information, steering information, and/or other information associated with towing of the towable object 106 by the vehicle 104.

The vehicle 104 may be a truck, car, or other type of vehicle. The towable object 106 may be a trailer, a camper, a boat, another vehicle, and/or any other item that can be towed by the vehicle 104. The vehicle 104 may have a hitch 112 and/or other elements to which the towable object 106 can be attached, such that the vehicle 104 can tow the towable object 106 when the vehicle 104 is driven.

In some examples, the towable object 106 may include and/or carry other objects. For instance, the towable object 106 may be a trailer that carries a boat, or that carries one or more other types of objects. In some examples in which the towable object 106 includes a trailer, the towable object 106 may be considered to be the trailer alone. In other examples in which the towable object 106 includes a trailer, the towable object 106 may be considered to be a combination of the trailer and one or more objects that are mounted to and/or carried by the trailer.

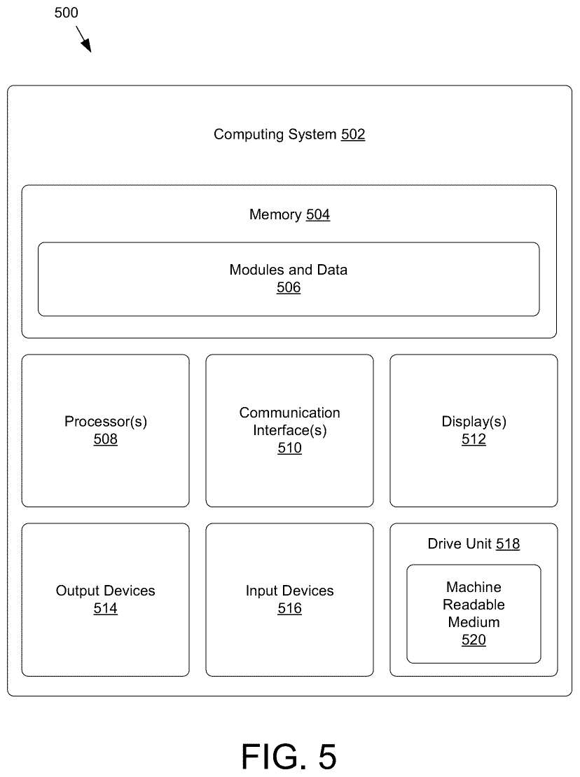

The smart towing assistant 102 may be executed by one or more computing systems, as discussed further below. An exemplary architecture of a computing system that may execute one or more elements of the smart towing assistant 102 is shown in FIG. 5, and is discussed further with respect to that figure.

In some examples, the smart towing assistant 102 may be executed at least in part via one or more computing systems that are integrated into the vehicle 104. For example, the vehicle 104 may have one or more on-board processors that may execute one or more elements of the smart towing assistant 102. In these examples, a driver or other user inside the vehicle 104 may use the smart towing assistant 102 via a dashboard display of the vehicle 104, integrated speakers and/or microphones of the vehicle 104, and/or other elements of the vehicle 104.

In other examples, the smart towing assistant 102 may be executed at least in part via one or more computing systems that are different and/or separate from the vehicle 104. As an example, the smart towing assistant 102 may be executed via a mobile phone, computer, or other computing device used by a user. As another example, a user may use a mobile phone, computer, or other computing device to access elements of the smart towing assistant 102 that are executed by a remote server, a cloud computing environment, and/or other computing systems. For instance, the smart towing assistant 102 may be accessible via a webpage, web portal, or other resource that a user can access over the Internet and/or other networks via a user device.

In some examples, elements of the smart towing assistant 102 may be distributed among, and/or be executed by, multiple computing systems. As an example, some elements of the smart towing assistant 102 may be executed via an on-board computing system of the vehicle 104 and/or a mobile phone of a user, while other elements of the smart towing assistant 102 may be executed via a remote server, a cloud computing environment, and/or other computing systems that can exchange data with the on-board computing system of the vehicle 104 and/or the mobile phone of the user via one or more networks. As another example, the smart towing assistant 102 may execute at least in part as an application that executes on a mobile user device, and the user may interact with the application via a dashboard system of the vehicle 104 when the user device is connected to the dashboard system via Apple CarPlay®, Android Auto™, or other systems.

As discussed above, the smart towing assistant 102 may receive input data, such as user input 108 and/or sensor data 110. In some examples, the user input 108 may be provided as text input, for instance via a user device, a dashboard system of the vehicle 104, and/or another interface. The user input 108 may also, or alternately, be provided as audio data via a microphone of a user device, the vehicle 104, or another system. The user input 108 may also, or alternately, be provided as image and/or video data via a camera of a user device, the vehicle 104, or another system. The user input 108 may also, or alternately, be provided as user selections of options presented by the smart towing assistant 102 and/or any other type of user input.

The vehicle 104, the towable object 106, and/or a user device associated with the smart towing assistant 102 may have one or more sensors 114. Such sensors 114 may capture corresponding sensor data 110 and provide the sensor data 110 to the smart towing assistant 102. The sensors 114 may include accelerometers and/or other motion sensors, Global Positioning System (GPS) sensors and/or other location sensors, sensors associated with a transmission and/or braking system of the vehicle 104, cameras and/or other image-based sensors, Light Detection and Ranging (LiDAR) sensors, microphones, proximity sensors, electrical connection sensors, data connection sensors, weight sensors, pressure sensors, payload sensors, and/or other types of sensors. In some examples, one or more types of sensors 114, such as microphones and/or cameras, may also be used to capture one or more types of user input 108 as described above.

In some examples, one or more types of sensors 114 may be built-in elements of the vehicle 104, the towable object 106, and/or a user device. In other examples, one or more types of sensors 114 may be separate or aftermarket elements that can be at least temporarily mounted, affixed, or otherwise installed on or in the vehicle 104 or the towable object 106.

The smart towing assistant 102 may have a user interface 116 that presents information to a user and/or accepts user input 108 from the user. In some examples, the user interface 116 may be a graphical user interface (GUI) that may be displayed via a screen, such as dashboard screen of the vehicle 104 or a screen of a user device. In other examples, the user interface 116 may include a non-visual interface, such as an audio-based interface such that the smart towing assistant 102 may present or convey information to a user via audio with or without also displaying the information visually via a screen. For example, the smart towing assistant 102 may be an audio-based system that can receive user input 108 as audio voice input captured by a microphone of the vehicle 104 or a user device, and that may audibly present corresponding output voice data via speakers of the vehicle 104 or the user device. Accordingly, in these examples, a user may have a voice-based audio conversation with the smart towing assistant 102 instead of, or in addition to, interacting with the smart towing assistant 102 via a screen or other visual interface.

In certain embodiments, the smart towing assistant 102 and/or the user interface 116 may include or comprise one or more local or remote processors, servers, transceivers, sensors, memory units, mobile devices, wearables, smart watches, smart contact lenses, smart glasses, augmented reality (AR) glasses, virtual reality (VR) headsets, mixed or extended reality glasses or headsets, voice bots, chatbots, ChatGPT or ChatGPT-based bots, and/or other electronic or electrical components, which may be in wired or wireless communication with one another. For instance, in one embodiment, a chatbot may provide information to the user (and/or receive information or input from the user), such as driving or steering directions and/or questions, via AR glasses and/or the chatbot.

The smart towing assistant 102 may have a chatbot 118 that can process user input 108, sensor data 110, and/or other data, and generate corresponding responses that may be output by the smart towing assistant 102. Accordingly, in some examples, a user of the smart towing assistant 102 may engage in a voice-based and/or text-based conversation with the smart towing assistant 102 via the chatbot 118. For instance, as described further below, the user may interact with the chatbot 118 to inquire about safety information and/or insurance coverage information related to towing the towable object 106 with the vehicle 104, and the chatbot 118 may respond by providing such safety information and/or insurance coverage information to the user.

The chatbot 118 may be based upon a generative artificial intelligence (AI) system that can generate natural language text and/or audio responses to input data, such that a user can converse with the chatbot 118 naturally by asking free-form questions or making other natural language statements, and receiving corresponding natural language responses generated by the chatbot 118 instead of, or in addition to, prewritten responses or predetermined information. The chatbot 118 may generate natural language output that expresses information conversationally via serious and/or humorous statements, that responds to statements and/or questions input by the user most recently and/or earlier during a conversation, that poses questions to the user, and/or that otherwise converses with the user.

In examples in which user input 108 is audio-based voice data, the chatbot 118 and/or other elements of the smart towing assistant 102 may use voice-to-text systems, natural language processing (NLP), and/or other types of audio processing to interpret the audio-based voice data provided by the user. In other examples in which user input 108 is text-based, the chatbot 118 and/or other elements of the smart towing assistant 102 can similarly use NLP and/or other types of text processing systems to interpret text provided by the user.

In some examples, the chatbot 118 may be based upon a generative pre-trained transformer (GPT) model, similar to other GPT-based models such as ChatGPT®. Such a GPT-based chatbot can be based upon a large language model. One or more models associated with the chatbot 118 and may be trained by a model training system 120 using supervised learning, reinforcement learning, and/or other machine learning techniques.

For example, one or more models associated with the chatbot 118 may be trained, by the model training system 120, based upon a towing-related training dataset. As discussed further below, the towing-related training dataset used by the model training system 120 to train the chatbot 118 may be based upon one or more types of information that may be provided and/or maintained by one or more sources, such as manufacturer data 122, towing safety information 124, insurance policy data 126, driving and steering information (such as directions and instructions), and/or other types of information. Accordingly, the chatbot 118 can be trained to provide safety information, insurance coverage information, driving information, steering information, and/or other information related to towing during a conversation with a user, and/or to steer a conversation with a user to such towing-related topics.

The model training system 120 may be a computer-executable system that is configured to train one or more models associated with the chatbot 118. In some examples, the model training system 120 may be at least partially separate from the smart towing assistant 102 and can execute to train and/or re-train an instance of the chatbot 118, such that the trained instance of the chatbot 118 can be deployed in the smart towing assistant 102. The model training system 120 may train the chatbot 118 to, during a conversation, generate conversational statements and/or other output related to towing proactively and/or in response to user questions or statements. The chatbot 118 may generate such statements or other output based upon information that was in the towing-related training dataset at the time the chatbot 118 was trained and/or based upon other information that can be accessed by the chatbot 118.

As discussed above, the model training system 120 may train one or more models associated with the chatbot 118 via supervised learning, reinforcement learning, and/or other machine learning techniques. For example, the model training system 120 may train the chatbot 118 based upon supervised learning using labeled data within the towing-related training dataset, such that the training causes the chatbot 118 to predict which labeled data is responsive to example user questions.

The chatbot 118 may also be trained to generate towing-related statements in response to example user questions, and the towing-related statements generated by the chatbot 118 may be manually reviewed to determine whether the towing-related statements generated by the chatbot 118 adequately respond to the example user questions. For instance, manual feedback may indicate whether or not the towing-related statements generated by the chatbot 118 covered accurate and relevant information, sufficiently responded to the example user questions, and/or were readable and understandable by humans. Feedback provided during such manual review can be used via Reinforcement Learning from Human Feedback (RLHF) techniques to further train or retrain the chatbot 118.

After the chatbot 118 has been trained, the chatbot 118 may be deployed in the smart towing assistant 102. The chatbot 118 may accordingly generate responses to user questions related to towing during conversations, and/or proactively steer such conversations towards towing-related topics. Statements and/or other output generated by the chatbot 118 during such conversations may be based upon information that was in the towing-related training dataset when the chatbot 118 was trained, and/or that is based upon similar or additional information that is stored by the smart towing assistant 102 and/or can be accessed by the smart towing assistant 102 from one or more other sources. As discussed above, the towing-related training dataset used to train the chatbot 118, and/or other information that may be accessed and/or used by the chatbot 118, may include manufacturer data 122, towing safety information 124, insurance policy data 126, driving data, steering data, and/or other types of information.

The manufacturer data 122 may indicate attributes of vehicles and/or towable objects, including attributes related to towing capabilities of vehicles, weights of towable objects, information indicating how to connect towable objects to vehicles, and/or other information provided by manufacturers or other providers of vehicles and/or towable objects. As an example, the manufacturer data 122 may indicate how much weight a particular vehicle is capable of towing, and/or how the weight of a particular towable object.

As another example, the manufacturer data 122 may indicate types of connectors, such the hitch 112, that can be used to connect particular towable objects to particular vehicles during towing. The manufacturer data 122 can be maintained in one or more databases or other data repositories, for instance in one or more databases maintained by manufacturers, an operator of the model training system 120 and/or a provider of the smart towing assistant 102.

The towing safety information 124 may indicate information associated with safely towing towable objects with vehicles. The towing safety information 124 may, for example, include articles, videos, and/or other media conveying information about safe towing connections between vehicles and towable objects, safe driving practices while towing, how to safely respond to towing-related emergencies, and/or other towing safety topics. The towing safety information 124 may be a set of media that is generated, compiled, and/or curated by an operator of the model training system 120 and/or a provider of the smart towing assistant 102. For example, if the operator of the model training system 120 and/or a provider of the smart towing assistant 102 is an insurance company as discussed further below, the insurance company may generate and/or curate the towing safety information 124 such that the towing safety information 124 conveys towing safety tips and other pieces of safety information that have been approved by the insurance company.

The insurance policy data 126 may indicate information associated with towing-related insurance coverage provided and/or offered by an insurance company, existing insurance policies provided by the insurance company that include and/or do not include towing insurance coverage, rates and/or options for adding towing insurance coverage to insurance policies, and/or other information. In some examples, towing insurance coverage may be Usage-Based Insurance (UBI), such as usage-based towing insurance coverage, as described further below. The insurance policy data 126 may be maintained in one or more databases or other data repositories, for instance in one or more databases maintained by an insurance company that are accessible by the model training system 120 and/or the smart towing assistant 102. As an example, the operator of the model training system 120 and/or the provider of the smart towing assistant 102 may be, or may be associated with, the insurance company that maintains the insurance policy data 126.

Overall, the model training system 120 may train the chatbot 118 on the manufacturer data 122, the towing safety information 124, the insurance policy data 126, steering and/or driving data, and/or other training data such that the chatbot 118 can hold a conversation about towing-related topics with a user of the smart towing assistant 102. In some examples, the chatbot 118 may also access and/or use manufacturer data 122, towing safety information 124, insurance policy data 126, steering and driving data, and/or other data during a conversation with a user, including information that was and/or was not used to train the chatbot 118.

The chatbot 118 may accordingly be trained and configured to answer user questions about towing-related topics during a conversation with a user, and/or proactively steer the conversation towards towing-related topics. The chatbot 118 may determine output presented to the user via text, audio, and/or other media during the conversation based upon how the chatbot 118 has been trained by the model training system 120, based upon manufacturer data 122, towing safety information 124, insurance policy data 126, steering data, driving data, and/or other data maintained separately from the smart towing assistant 102, based upon user input 108, sensor data 110, and/or other types of input data provided to the smart towing assistant 102, and/or based upon other data.

In some examples, towing-related information conveyed by the chatbot 118 during a conversation with a user may be based upon, at least in part, identification of the vehicle 104 and/or the towable object 106 associated with the user, such as identification of a particular type, make, and/or model of the vehicle 104 or the towable object 106. For example, as discussed above, weights, towing capabilities, and/or other information about the vehicle 104 and/or the towable object 106 can be indicated by the manufacturer data 122, such that the chatbot 118 may determine such information based upon identifiers of the vehicle 104 and/or the towable object 106.

Identifiers of the vehicle 104 and/or the towable object 106 associated with the user may be indicated via user input 108 and/or other data stored by, or accessible by, the smart towing assistant 102. In some examples, a user of the smart towing assistant 102 may be a customer of an insurance company, and may log in to the smart towing assistant 102 via a customer identifier, account number, or policy number that the insurance company associates with the user. If the vehicle 104 and/or the towable object 106 are insured via an existing insurance policy with the insurance company, the smart towing assistant 102 may access and use insurance policy data 126 to identify the vehicle 104 and/or the towable object 106 that the user may reference during a conversation with the chatbot 118.

In other examples, the user may provide a text description of the vehicle 104 and/or the towable object 106, a photograph of the vehicle 104 and/or the towable object 106, and/or other user input 108 about the vehicle 104 and/or the towable object 106. Accordingly, the chatbot 118 and/or other elements of the smart towing assistant 102 may identify the vehicle 104 and/or the towable object 106 based upon the provided user input 108, and/or look up or estimate information about the vehicle 104 and/or the towable object 106.

As an example, if the towable object 106 is a boat, a user may provide a photograph of the boat to the smart towing assistant 102, such that the smart towing assistant 102 may use image recognition techniques to identify the type and/or model of the boat and/or estimate information associated with the boat. For instance, if the smart towing assistant 102 is able to identify the exact type or model of the boat based upon the user-provided photograph, the smart towing assistant 102 may use the manufacturer data 122 to look up corresponding information about the boat. However, if the smart towing assistant 102 is unable to identify the exact type or model of the boat, the smart towing assistant 102 may also be configured to use information in the photograph to estimate the weight, size, and/or other attributes of the boat.

As discussed above, the chatbot 118 may be configured to provide towing-related information in response to user inquires, and/or to proactively provide towing-related information to a user. As an example, if a user associated with the vehicle 104 is not experienced with towing, the user may be unsure what objects, and/or how much weight, the vehicle 104 is capable of towing. The user may ask questions about such topics via the chatbot 118, and the chatbot 118 can provide corresponding answers to the user. For instance, based upon an identification of the vehicle 104, and the chatbot 118 having been trained on and/or being able to access manufacturer data 122 that indicates capabilities of the vehicle 104, the chatbot 118 may provide the user with information indicating how much weight the vehicle 104 is capable of towing.

Similarly, the user may ask the chatbot 118 whether the vehicle 104 can safely tow the towable object 106, and/or how to safely connect the towable object 106 to the vehicle 104. The chatbot 118 may respond with corresponding answers and/or safety information associated with towing of the towable object 106 by the vehicle 104. As discussed above, the smart towing assistant 102 can access and/or be provided with information that identifies the type, make, and/or model of the vehicle 104 and the towable object 106. The chatbot 118 may also have been trained on, and/or is able to access, manufacturer data 122 that indicates attributes of the vehicle 104 and/or the towable object 106, and/or towing safety information 124 indicating how to safely use the hitch 112 of the vehicle 104. Accordingly, the chatbot 118 may provide the user with corresponding information indicating whether the whether the vehicle 104 can safely tow the towable object 106, and/or information instructing the user how to use the hitch 112 to connect the towable object 106 to the vehicle 104.

As an example, manufacturer data 122 may indicate that the vehicle 104 is capable of towing up to 3000 pounds, but that the towable object 106 weighs 5000 pounds. Accordingly, in this example, the chatbot 118 may indicate to the user that the towable object 106 cannot safely be towed by the vehicle 104. However, if the manufacturer data 122 instead indicates that the towable object 106 weighs 3000 pounds or less, the chatbot 118 may indicate to the user that the towable object 106 can safely be towed by the vehicle 104.

The chatbot 118 may generate natural language output to convey information in response to a user's question. For instance, the chatbot 118 may display text responses to a user's question in the user interface 116 via a display, and/or user text-to-voice systems to present audio answers to a user's question. However, in some examples, the chatbot 118 may also, or alternately, cause the smart towing assistant 102 to present videos or other media via the user interface 116 in response to a user's question. For instance, if the towing safety information 124 includes a video explaining how to safely use the hitch 112 of the vehicle 104, the smart towing assistant 102 can download or stream the video via a network, or can access a locally-stored copy of the video, such that the smart towing assistant 102 can play the video for the user.

The chatbot 118 may, in some examples, select a video from a set of videos stored in the towing safety information 124 based upon a type of the vehicle 104, a type of the towable object 106, a type of the hitch 112, and/or other information. For instance, if the chatbot 118 determines to present a how-to video to the user instructing the user how to use the hitch 112, the chatbot 118 may select a first video if the hitch 112 is an articulating hitch, but may select a second video if the hitch 112 is a static hitch.

The chatbot 118 may provide other towing-related information to a user, in response to user queries and/or proactively during a conversation, including driving and/or steering instructions. For example, the chatbot 118 may instruct a user how to inspect lights and/or other elements of the towable object 106 to confirm that such elements are or will be working during towing, indicate safe driving speeds the driver should adhere to while towing the towable object 106 with the vehicle 104, indicate safety tips on how to navigate traffic while towing the towable object 106 with the vehicle 104, indicate tips on how to safely park while the towable object 106 is connected to the vehicle 104, indicate tips on how to safely back up the vehicle 104 while the vehicle 104 is connected to the towable object 106, and/or other types of towing-related information.

As an example of other towing-related information and/or driving or steering information, the chatbot 118 may suggest to a driver of the vehicle 104 user that that the driver make wider turns than normal, allow more space than normal when making lane changes, allow more space than normal when parking, and/or take other differing actions while driving with the towable object 106 attached to the vehicle 104. As additional examples of other towing-related information, and/or driving and/or steering instructions, the chatbot 118 may provide route information and directions (such as either verbally or visually/textually), and/or instructions as to when the driver should turn the steering wheel to make a turn or when backing up, or when backing up into a tight area, such as a camping site.

In some examples, the chatbot 118 may also take one or more other types of information into account when generating towing-related output to display to a user. For example, the chatbot 118 may ask the user for route information about a route the user plans to drive while the towable object 106 is connected to the vehicle 104. The chatbot 118 may determine customized safety information based upon slopes or grades of portions of the route, current and/or predicted weather conditions, sensor data 110 indicating weight of a payload carried by the towable object 106, and/or other information in addition to user input 108, manufacturer data 122, and/or towing safety information 124.

For example, if the weight of the towable object 106 is close to a weight limit that manufacturer data 122 indicates the vehicle 104 can safely tow, but a downhill portion of the user's planned route has a slope that due to gravity would cause the vehicle 104 to have less control of the towable object 106 or expected weather conditions may negatively impact the ability of the vehicle 104 to safely tow the weight of the towable object 106, the chatbot 118 may provide that information to the user and/or suggest that the user take an alternate route or drive more slowly while traversing one or more portions of the planned route.

The chatbot 118 may also be configured to provide insurance-related information, and/or cause changes to insurance policies, based upon interactions with users. For example, a user may be policyholder that has an insurance policy with an insurance company, and the insurance policy data 126 may include information about the user's insurance policy. However, the user may be unsure whether the user's insurance policy provides insurance coverage for towing the towable object 106 with the vehicle 104, coverage limits, rates, and/or other attributes of existing towing coverage, which of the user's vehicles are covered by towing insurance coverage, whether the user needs towing insurance coverage, the risks of towing the towable object 106 without towing insurance coverage, how to add towing insurance coverage to the user's insurance policy, and/or other types of information.

Accordingly, the user can ask questions about such topics to the chatbot 118, and the chatbot 118 can respond with information specific to the user's insurance policy based upon the insurance policy data 126. For example, if the user does not know whether the user's insurance policy includes towing related coverage that would cover towing the towable object 106 with the vehicle 104, the user can ask the chatbot 118 and the chatbot 118 can accordingly indicate, based upon the insurance policy data 126, whether the user's insurance policy does or does not cover towing the towable object 106 with the vehicle 104.

In some examples, if the user's insurance policy does not include towing coverage, or the limits of existing towing coverage would not cover towing the towable object 106 with the vehicle 104, the chatbot 118 may be configured to generate and present an insurance quote for adjusting the user's insurance policy to add towing coverage or change towing coverage. In some examples, the chatbot 118 may suggest or recommend usage-based towing coverage to the user, for instance based upon information about a frequency of towing events that the user has engaged in or plans to engage in, information about how much experience the user has with towing, and/or other information described herein. The chatbot 118 may be trained based upon insurance policy data 126 to determine coverage limits, premiums, and/or other attributes of the insurance quote, for instance based upon other current and/or historical insurance policies indicated by the insurance policy data 126 that include towing coverage, are associated with the same or similar types of vehicles and/or towable objects, are associated with a similar geographic location and/or other demographics of the user, are associated with similar insurance claim histories as the user, and/or other data.

In other examples, the insurance quote for adjusting the user's insurance policy to include or change towing coverage may be generated by other systems associated with the insurance company, but can be presented to the user via the chatbot 118. In some examples, the user may also provide user input 108 accepting the new insurance quote presented via the chatbot 118, and the smart towing assistant 102 can submit information to servers and/or other systems of the insurance company that maintain the insurance policy data 126 in order to make and/or bind the changes to the user's insurance policy based upon the accepted insurance quote.

In some examples, the chatbot 118 may be configured to steer a conversation with a user to ask the user questions and/or receive user input 108 indicating how much experience a user has with towing. The chatbot 118 and/or other elements of the smart towing assistant 102 may be configured to estimate a towing experience level of the user based upon such information provided during a conversation with the user, such that the chatbot 118 can generate output during the conversation based upon the estimated towing experience level of the user. The chatbot 118 and/or other elements of the smart towing assistant 102 may compare the user's estimated towing experience level against one or more threshold experience levels, such that the chatbot 118 can determine output based at least in part on the user's estimated towing experience level relative to the one or more threshold experience levels.

For instance, if the user indicates during the conversation that the user has a relatively low level of experience with towing, the chatbot 118 can output general safety tips associated with towing, and/or specific information associated with safely towing the towable object 106 with the vehicle 104. As an example, the chatbot 118 may present a how-to video indicating how to connect the towable object 106 to the vehicle 104. As another example, the chatbot 118 may present a checklist of items to check to ensure that the towable object 106 is attached to the vehicle 104 before towing, so that the user can verify that the towable object 106 is securely connected to the hitch 112, that safety chains or cables are connected, that brake lights, blinkers, running lights, and/or other elements of the towable object 106 are working properly, and/or take other actions based upon the checklist.

In some examples, a user's conversation with the chatbot 118 may demonstrate that the user has sufficient experience with towing, and/or has learned sufficient towing-related information about towing during the conversation, such that the chatbot 118 or other elements of the smart towing assistant 102 can determine that the user has less than a threshold risk of damaging the vehicle 104, the towable object 106, and/or other objects during towing of the towable object 106 with the vehicle 104. Accordingly, the chatbot 118 or other elements of the smart towing assistant 102 may determine, based upon the conversation with the user, that the user is eligible for a discount on towing insurance coverage. The smart towing assistant 102 may submit corresponding information to servers and/or other systems of the insurance company that maintain the insurance policy data 126 in order to adjust the user's insurance policy based upon the discount and/or indicate that the user is eligible for the discount.

In some examples, the user may initiate a conversation with the chatbot 118 can be used by a user at any time, such as before towing and/or during towing. In other examples, the chatbot 118 may initiate a towing-related conversation with a user in response to detection of a towing event or an expected towing event by a towing detector 128 of the smart towing assistant 102.

The towing detector 128 of the smart towing assistant 102 may be configured to use user input 108 and/or sensor data 110 to detect a current or future towing activity when the towable object 106 is connected to the vehicle 104 and/or is being towed by the vehicle 104. Accordingly, when the towing detector 128 detects a current or future towing activity, the detection of the current or future towing activity may be used as a trigger event to proactively initiate a conversation with the user about towing-related topics via the chatbot 118 if such a conversation has not already occurred or is not already in progress.

As an example, if the towing detector 128 detects that the towable object 106 has been connected to the vehicle 104, the chatbot 118 may proactively provide safety tips to the user about how to safely tow the towable object 106 with the vehicle 104. If the user has towing insurance coverage according to the insurance policy data 126, the chatbot 118 may also confirm to the user whether the user's current towing insurance coverage covers towing of the towable object 106 with the vehicle 104. If insurance policy data 126 indicates that the user does not yet have towing insurance coverage that would cover towing of the towable object 106 with the vehicle 104, the chatbot 118 may suggest that the user obtain such towing insurance coverage and/or provide a quote for such towing insurance coverage. In some examples, the chatbot 118 may suggest usage-based towing insurance coverage to a user, for instance if an estimated towing experience level of the user that has been determined by the smart towing assistant 102 indicates that the user is likely to engage in towing activities relatively infrequently.

As discussed further below, in some examples detection of towing activity by the towing detector 128 can also, or alternately, be used to provide towing usage data 130 associated with the towing activity to a Usage-Based Insurance (UBI) system 132. Accordingly, if a user has usage-based towing insurance coverage, the usage-based insurance system 132 can bill the user based upon a number of instances of towing activity and/or durations of towing activity indicated by the towing usage data 130, as discussed further below.

In some examples, the towing detector 128 may detect towing activity based upon user input 108 that indicates that the towable object 106 has been connected to the vehicle 104 and/or that the user is towing, or intends to tow, the towable object 106 with the vehicle 104. However, the towing detector 128 may also, or alternately, automatically detect towing activity based upon sensor data 110 provided by sensors 114 of the vehicle 104, the towable object 106, and/or other systems.

As an example, the towable object 106 may have brake lights or other electrical components, and the hitch 112 and/or other elements of the vehicle 104 can have an electrical outlet, electrical port, or other electrical connectors that can provide electrical power to the towable object 106. The vehicle 104 and the towable object 106 may also, or alternately, have Ethernet ports or other types of data connections that can be used to establish a data connection between elements of the vehicle 104 and the towable object 106. In these examples, sensors 114 of the vehicle 104 and/or the towable object 106 may indicate when electrical and/or data connections have been made between the vehicle 104 and the towable object 106, and the towing detector 128 can use corresponding sensor data 110 to detect when the towable object 106 has been connected to the vehicle 104 for towing.

As another example, one or more weight or pressure sensors associated with the hitch 112 may be configured to detect when a towable object has been connected to the hitch 112. Similarly, a backup camera of the vehicle 104, a proximity sensor, and/or other sensors 114 may provide image data or other types of sensor data 110 indicating when a towable object is present behind the vehicle 104. Accordingly, sensor data 110 captured by such sensors 114 can be provided to towing detector 128, such that the towing detector 128 can use the sensor data 110 to detect when the towable object 106 has been connected to the vehicle 104 for towing.

As yet another example, sensor data 110 provided to the towing detector 128 while the vehicle 104 is driving may indicate to the towing detector 128 whether or not the vehicle 104 is towing a towable object. For example, sensor data 110 indicating operations of the transmission or weight of the vehicle 104, acceleration and/or braking rates of the vehicle 104, and/or other operations of the vehicle 104 while driving without towing any towable objects can be used by the towing detector 128 to establish a baseline profile associated with non-towing activity of the vehicle 104. In some examples, the baseline profile associated with non-towing activity of the vehicle 104 may be a predetermined profile based upon a type or model of the vehicle 104 or similar vehicles.

The towing detector 128 may be configured to detect when sensor data 110 differs from the non-towing baseline profile and indicates when the vehicle 104 is towing a towable object, such that the towing detector 128 can use such sensor data 110 to detect towing activity. As an example, when the vehicle 104 is towing the towable object 106, sensor data 110 may indicate that the vehicle 104 accelerates and/or decelerates more slowly than when the vehicle 104 is not towing anything, and/or may indicate that the vehicle 104 handles differently while turning corners relative to when the vehicle 104 is not towing anything. The towing detector 128 may accordingly use such sensor data 110 to detect towing activity while the vehicle 104 is driving.

As discussed above, detection of towing activity by the towing detector 128 may be used as a trigger to initiate a towing-related conversation with a user via the chatbot 118. However, detection of towing activity by the towing detector 128 may also, or alternately, be used to generate and/or output towing usage data 130 associated with detected towing activity. The towing usage data 130 may indicate, for example, start times, end times, and/or durations of an instance of towing activity detected by the towing detector 128.

The towing usage data 130 may also indicate GPS coordinates or other location data indicating a route traveled by the vehicle 104 while the vehicle 104 was towing the towable object 106, and/or any other information associated with the detected towing activity. The towing usage data 130 may be used by the usage-based insurance (UBI) system 132 to determine when and/or how much to bill an insured party associated with the vehicle 104 and/or the towable object 106 in association with usage-based towing insurance coverage.

The smart towing assistant 102 may be configured to transmit the towing usage data 130 to the usage-based insurance system 132 periodically or in real-time. For example, the computing system that executes the smart towing assistant 102 may have cellular data connections or other wireless data connections that the smart towing assistant 102 can use to transmit the towing usage data 130 to the usage-based insurance (UBI) system 132 via the Internet or other networks. Accordingly, the usage-based insurance system 132 may use the towing usage data 130 to determine how often the vehicle 104 is used for towing, durations of towing events that the vehicle 104 engages in, and/or other information associated with towing activity the vehicle 104 engages in.

In some examples, the usage-based insurance system 132 may have an instance of the towing detector 128 that executes separately from the smart towing assistant 102. In these examples, the towing usage data 130 sent to the usage-based insurance system 132 by the smart towing assistant 102 may be or include sensor data 110 provided to the smart towing assistant 102. Accordingly, the instance of the towing detector 128 at the usage-based insurance system 132 can use the sensor data 110 to detect instances of towing activity separately and/or independently from the smart towing assistant 102.

As an example, an accelerometer and/or other sensors 114 of a user device, a hardware module provided by an insurance company, or any other system may capture sensor data 110 while the vehicle 104 is driving. Such user device, hardware module, or other system may execute one or more elements of the smart towing assistant 102 as discussed above. The user device, hardware module, or other system may provide sensor data 110 captured by one or more sensors 114 to the usage-based insurance system 132 separately or via the smart towing assistant 102. Accordingly, an instance of the towing detector 128 that executes at the usage-based insurance system 132, instead of as part of the smart towing assistant 102, may use the sensor data 110 to detect towing activity. For instance, as discussed above, the towing detector 128 may determine whether accelerometer data or other sensor data 110 indicates differences from a non-towing baseline profile and is thereby indicative of towing activity.

The usage-based insurance system 132 may access insurance policy data 126 indicating whether an insurance policy associated with the vehicle 104 and/or the towable object 106 includes usage-based coverage of towing activity. Some insurance policies may offer full coverage of towing activity, such that a policyholder is billed for towing coverage every month or otherwise in association with an entire term. However, usage-based towing coverage may instead cover towing activity based upon a number of instances of actual towing activity, durations of actual instances of towing activity, distances traveled during actual instances of towing activity, and/or other metrics associated with actual instances of towing activity.

In some situations, such usage-based towing coverage may be cheaper for policyholders. For example, if a particular policyholder only engages in towing activity infrequently, such as two or three times a year, the risk of towing-related accidents associated with that policyholder may be lower than the risk of towing-related accidents associated with other policyholders who engage in towing activity multiple times per week.

Therefore, it may be cheaper for the policyholder to have usage-based towing coverage that the policyholder pays for based upon the actual infrequent instances of towing activity relative to being billed each month or throughout an entire term for towing coverage. Accordingly, when the towing usage data 130 indicates that the vehicle 104 is or has engaged in an instance of actual towing activity, the usage-based insurance system 132 may adjust insurance policy data 126 to increment data indicating a number and/or cumulative duration of towing activity associated with a corresponding usage-based towing insurance policy, and/or cause a corresponding policyholder to be billed based upon the detected towing activity.

In some examples, a billing amount associated with a usage-based towing insurance policy during a billing period may be determined by the usage-based insurance system 132 based upon a number of instances of actual towing activity, durations of actual instances of towing activity, distances traveled during actual instances of towing activity, and/or other metrics associated with actual instances of towing activity indicated by the towing usage data 130. In other examples, a usage-based towing insurance policy may be associated with a preset billing amount, but the usage-based insurance system 132 may decrease the preset billing amount during a billing period based upon the number of instances of actual towing activity, durations of actual instances of towing activity, distances traveled during actual instances of towing activity, and/or other metrics associated with actual instances of towing activity indicated by the towing usage data 130. For instance, a policyholder can receive a discount that decreases the preset billing amount during a particular billing period if the towing usage data 130 indicates that the policyholder did not engage in towing activity during that particular billing period.

The usage-based insurance system 132 may also, in some examples, use one or more other types of data, in addition to and/or in combination with the towing usage data 130, to determine how much a policyholder is to be billed for usage-based towing insurance coverage during a billing period. For example, towing usage data 130 indicating a route traveled by the vehicle 104 while towing the towable object 106, times at which the vehicle 104 traveled through portions of the route while towing the towable object 106, and/or other information may be used to correlate corresponding traffic data, geographical data, weather data, visibility data, and/or other data that may allow the usage-based insurance system 132 to determine a risk associated with the towing activity.

The usage-based insurance system 132 may determine a billing amount associated with the towing activity based at least in part with the determined risk of the towing activity, such that riskier towing activities are billed at a higher amount than less-risky towing activities. For example, location data may indicate that towing activity risk is higher in locations where traffic was heavier, and/or at portions or a route with steep downslopes or tighter turns.

As another example, if time data within the towing usage data 130 indicates that towing activity occurred at night when visibility was likely to have been reduced, and/or occurred during rush hour or other times associated with heavier traffic patterns, the usage-based insurance system 132 may determine that the risk of the towing activity was higher at that time than the risk would have been at other times. As a further example, if weather data indicates that towing activity occurred when and where precipitation was falling, and/or when or where snow or ice likely covered roads, the usage-based insurance system 132 may determine that the risk of the towing activity was higher than the risk would have been during dry weather conditions.

In some examples, a machine learning model associated with the towing detector 128 and/or the usage-based insurance system 132 may be trained to determine towing usage data 130 and/or a corresponding risk indicated by the towing usage data 130 based upon sensor data 110 and/or corresponding traffic data, geographical data, weather data, visibility data, and/or other data. For example, an instance of the towing detector 128 at the smart towing assistant 102 and/or at the usage-based insurance system 132 may be based at least in part on a machine learning model that has been trained to use one or more types of attributes indicated by sensor data 110, such that the towing detector 128 can identify a baseline profile of non-towing activity and predict when new sensor data 110 is different from the baseline profile and is likely indicative of towing activity as discussed above. The same machine learning model or a different machine learning model associated with the usage-based insurance system 132 may also be trained to predict risks associated with detected towing activities, for instance based upon attributes within the towing usage data 130 and/or corresponding traffic data, geographical data, weather data, visibility data, and/or other data.

One or more machine learning models associated with detecting towing activity and/or predicting risks associated with detected towing activity may be trained by the model training system 120 or a different model training system based upon a training data set using supervised machine learning, unsupervised machine learning, or other machine learning techniques. For example, a training data set may include historical data indicating sensor data 110 that has been labeled to indicate data associated with instances of towing activity and non-towing activity. The historical data may indicate sensor data 110 associated with travel of one or more types of vehicles traveling in different environmental conditions and/or different locations while not towing and/or while towing one or more types of towable objects.

Accordingly, a machine learning model may be trained to determine which types of data, which values of the data, and/or which other attributes indicated by the training data set are predictive of the labeled instances of towing activity and non-towing activity. Similarly, a training data set may include historical data labeled to indicate risk levels associated with various known towing activities, such that a machine learning model may be trained to determine which types of data, which values of the data, and/or which other attributes indicated by the training data set are predictive of the labeled risk levels. After such machine learning models have been trained, the machine learning models can process new sensor data 110 and/or towing usage data 130 as discussed above to predict whether the sensor data 110 is likely associated with towing activity, and/or to predict a risk level associated with the towing activity that can be used to determine a billing amount associated with the risk level.

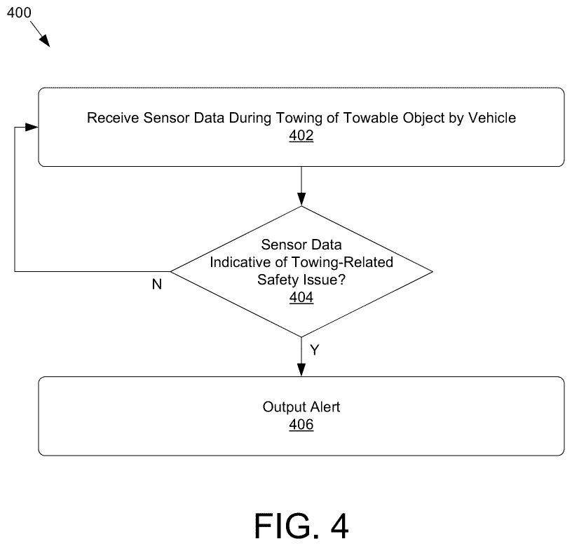

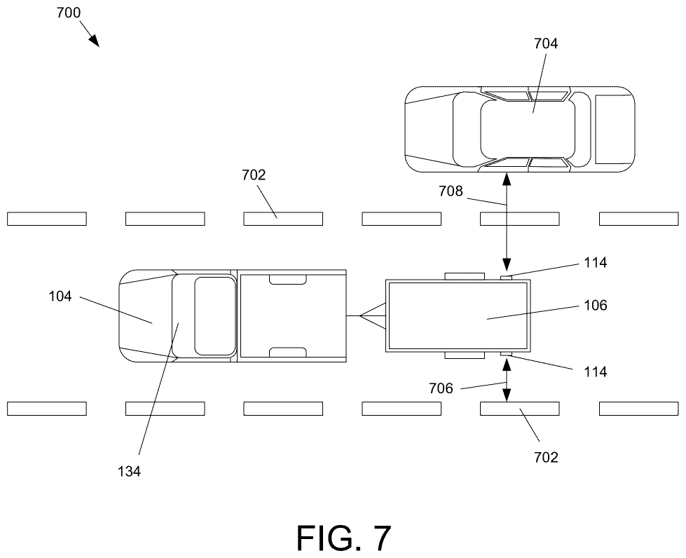

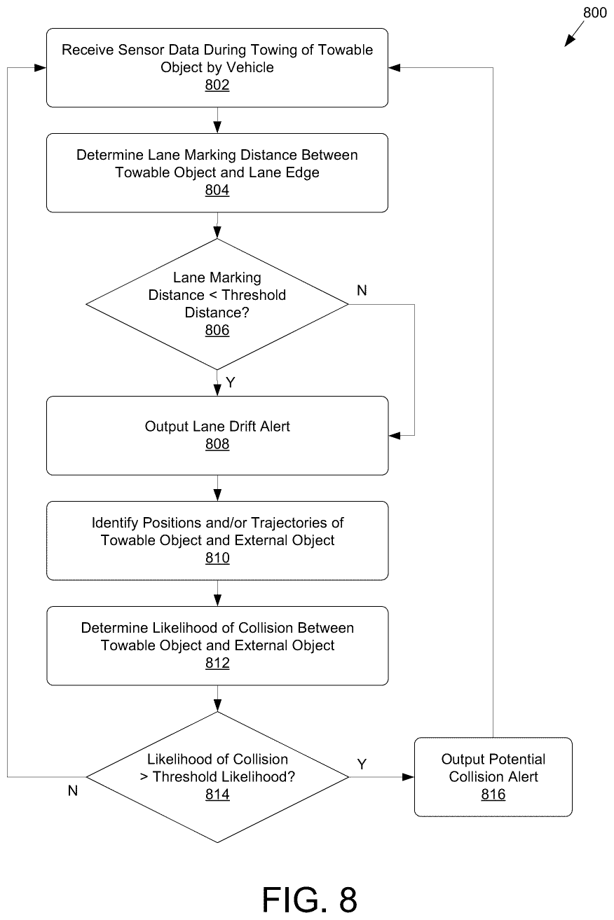

Sensor data 110 captured by sensors 114 may also be used by a towing lane assist system 134 of the smart towing assistant 102 instead of, or in addition to, being used by the towing detector 128 to detect instances of towing activity. The towing lane assist system 134 may be configured to use the sensor data 110 to detect towing-related safety issues associated with towing of the towable object 106 by the vehicle 104, and to present corresponding alerts to a driver of the vehicle 104. Although the towing lane assist system 134 can be an element of the smart towing assistant 102 as shown in FIG. 1, in some examples an instance of the towing lane assist system 134 may execute separately and/or independently from the smart towing assistant 102. The towing lane assist system 134 is discussed further below with respect to FIG. 4, FIG. 7, and FIG. 8.

The towing lane assist system 134 may be configured to alert a driver of the vehicle 104 if, during towing of the towable object 106 with the vehicle 104, the towable object 106 is at risk of veering into a different lane and/or is at risk of impacting another object during a lane change, while turning a corner, or during other situations. The towing lane assist system 134 may provide such an alert to the driver visually via the user interface 116 and/or other visual indicators, via audible sounds, via haptic feedback, and/or via any other type of indicia.

As an example, the sensors 114 may include cameras, proximity sensors, or other types of sensors that are permanently or temporarily mounted to the towable object 106. As an example, cameras may be mounted on the towable object 106 and may face outward from the sides of the towable object 106, behind the towable object 106, and/or forwards towards the vehicle 104. Accordingly, the cameras on the towable object 106 may capture image data of the environment surrounding the towable object 106. As another example, one or more cameras may be mounted on the vehicle 104 facing towards the towable object 106, such as a backup camera of the vehicle 104 or other rear-facing cameras.

The towing lane assist system 134 may receive image data from such cameras, and use image recognition techniques to identify a position of the towable object 106 relative to lane markings, other portions of a road, vehicles, and/or other objects. The towing lane assist system 134 may be configured analyze such image data to determine if the towable object 106 is at risk of veering into a different lane or is at risk of impacting another object during a lane change, while turning a corner, or during other situations, and if so, can alert the driver.

As another example, the towing lane assist system 134 may be configured to determine, based upon image data captured by one or more cameras, a distance between a side of the towable object 106 and lane markings. The towing lane assist system 134 may be configured to alert the driver if the distance between the side of the towable object 106 and lane markings decreases to below a threshold distance. In some examples, the towing lane assist system 134 may communicate with, and/or be integrated with, a turn indicator system of the vehicle 104, such that the towing lane assist system 134 alerts the driver if a detected distance between the side of the towable object 106 and lane markings decreases to below a threshold distance and the driver has not used turn signals to indicate that the driver intends to cross the lane markings as part of a lane change.

As another example, the towing lane assist system 134 may be configured to determine a current or expected trajectory of the towable object 106 during lane changes, cornering, and/or other driving operations, and determine whether the current or expected trajectory of the towable object 106 has at least a threshold likelihood of causing the towable object 106 to impact other vehicles or objects, drive off a road, or otherwise lead to other negative situations. In such situations, the towing lane assist system 134 may output a corresponding alert to inform the driver. The threshold likelihood may be set at a relatively low likelihood, such that the alert may be output if the towable object 106 is likely to impact other vehicles or objects, drive off a road, or experience another negative situation, or would come within a threshold distance of doing so.

As an example, the towing lane assist system 134 may use image data to detect a position of an adjacent vehicle relative to the position of the towable object 106. If the driver of the vehicle signals a lane change via a turn indicator system of the vehicle 104 or an imminent lane change is otherwise detected, for instance based upon a detected distance between the side of the towable object 106 and lane markings decreasing to below a threshold distance, the towing lane assist system 134 may determine that the towable object 106 has at least a threshold likelihood of impacting the adjacent vehicle. The towing lane assist system 134 may accordingly cause a visual and/or audible alert to be presented to the driver, such that the driver can take action to avoid the lane change and/or otherwise avoid colliding the towable object 106 with the adjacent vehicle.

In some examples, the vehicle 104 may have a native lane assist system that can alert a driver if the vehicle 104 itself is unexpectedly veering into a different lane and/or would impact other objects during lane changes or other driving operations. However, such a native lane assist system may be configured based upon the dimensions of the vehicle 104 itself, and not account for the towable object 106 and/or the combined dimensions of the vehicle 104 and the towable object 106 during towing. Accordingly, the towing lane assist system 134 can augment or replace the native lane assist system of the vehicle 104 when the vehicle 104 is towing the towable object 106.

As discussed above, user input 108 provided by the chatbot 118 and/or other information provided to and/or accessible by the smart towing assistant 102, such as insurance policy data 126 may identify the type, make, and/or model of the vehicle 104 and/or the towable object 106. The towing lane assist system 134 can use such identifiers to determine the combined dimensions of the vehicle 104 and the towable object 106 during towing, for instance based upon manufacturer data 122 that indicates the dimensions of the vehicle 104 and/or the towable object 106.

As discussed above also, the driver of the vehicle 104 may be a user of the smart towing assistant 102 who is relatively inexperienced with towing. The driver may accordingly not have the experience to recognize when the towable object 106 is veering into an adjacent lane when the vehicle 104 itself is still in the current lane, or whether the towable object 106 is at risk of colliding with other vehicles or objects during planned lane changes, corning, or other driving activities. However, the towing lane assist system 134 can alert the driver to such situations and thereby prevent potential accidents.

Overall, one or more elements associated with the smart towing assistant 102 can provide towing-related information to a user before and/or during towing of the towable object 106 by the vehicle 104. For example, the user may interact with the chatbot 118 via a natural language conversation so that the user can ask towing-related questions and/or receive towing-related information, such as safety tips, checklists, or other information that helps the user to safely tow the towable object 106 with the vehicle 104, and/or information indicating that the user does or does not have insurance coverage that covers towing of the towable object 106 with the vehicle 104. The chatbot 118 may, in some examples, also provide insurance quotes and/or bind changes to an insurance policy, for instance to add or adjust towing insurance coverage to the user's insurance policy.

Additionally, if the user has usage-based towing insurance, the smart towing assistant 102 may detect when the vehicle 104 is being used to tow the towable object 106 or other towable objects, and generate or provide towing usage data 130 such that the usage-based insurance system 132 can bill the user for detected towing activities in association with the usage-based towing insurance. The towing lane assist system 134 of the smart towing assistant 102 may also provide lane assist detection associated with towing of the towable object 106 by the vehicle 104 that can detect unsafe situations associated with the towable object 106 during lane changes or other driving actions, and alert the driver of the vehicle 104 of such unsafe situations in order to reduce the likelihoods of accidents during towing of the towable object 106 by the vehicle 104.

In some examples, providing towing-related safety information and/or alerts via the chatbot 118 and/or the towing lane assist system 134 may reduce the number of towing-related accidents. Accordingly, providing towing-related safety information and/or alerts via the chatbot 118 and/or the towing lane assist system 134 may also reduce the number of towing-related insurance claims that are submitted to an insurance company.

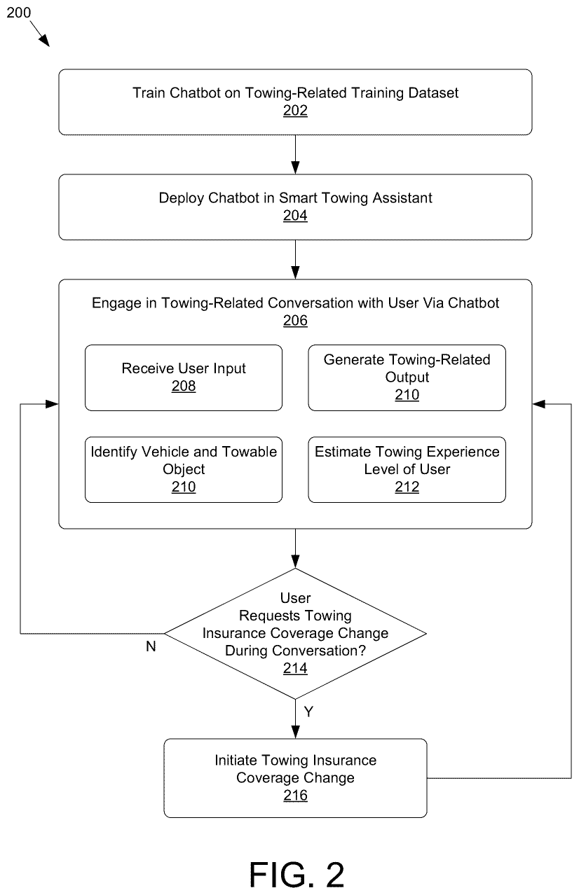

Flowcharts associated with operations associated with elements of the smart towing assistant 102, the model training system 120, the usage-based insurance system 132, and/or other elements described herein are discussed further below with respect to FIGS. 2-4. An example system architecture that can be used to execute the smart towing assistant 102 and/or other elements described herein is discussed further below with respect to FIG. 5.

### Exemplary Computer-Implemented Method

FIG. 2 shows a flowchart illustrating an exemplary computer-implemented method 200 for training and using the chatbot 118 associated with the smart towing assistant 102. The method 200 shown in FIG. 2 may be performed by one or more computing systems, such as a computing system that executes the model training system 120 and/or a computing system that executes the smart towing assistant 102. An exemplary computer system architecture for such a computing system is described below with respect to FIG. 5.

At block 202, the model training system 120 may train the chatbot 118 on a towing-related training dataset. The towing-related training dataset may be based upon one or more types of information that may be provided and/or maintained by one or more sources, such as manufacturer data 122, towing safety information 124, insurance policy data 126, steering and driving data, and/or other types of information. The chatbot 118 may be based upon a GPT model, such as a large language model, that is trained based the towing-related training dataset using supervised learning, reinforcement learning, and/or other machine learning techniques. The model training system 120 may train the chatbot 118 to generate conversational statements and/or other output related to towing proactively, and/or in response to user questions or statements, based upon information that was in the towing-related training dataset at the time the chatbot 118 was trained and/or based upon other information that can be accessed by the chatbot 118 after training of the chatbot 118.

At block 204, the trained chatbot 118 may be deployed in the smart towing assistant 102. As discussed above, the smart towing assistant 102 may execute via a user device, via a dashboard system or other on-board computing system of the vehicle 104, and/or via one or more servers or a cloud computing environment that may be separate and/or remote from a user device and the vehicle 104. As an example, the chatbot 118 may be deployed in an instance of the smart towing assistant 102 that at least partially executes on a remote server, but that a user can access via a web browser executing on a smartphone or other user device. As another example, the chatbot 118 may be deployed in an instance of the smart towing assistant 102 that executes on a smartphone or other user device, or via an on-board computing system of the vehicle 104, and may be accessed by the user via the user device and/or a dashboard system of the vehicle 104.

At block 206, the chatbot 118 may engage in a towing-related conversation with a user. In some examples, the towing-related conversation may be initiated by a user, for instance before or during a towing activity. In other examples, the chatbot 118 or another element of the smart towing assistant 102 may initiate the towing-related conversation, for instance in response to detection of current or expected towing activity based upon sensor data 110.

The chatbot 118 may engage in various operations during the towing-related conversation, such as receiving user input 108 at block 208, generating towing-related output at block 210, identifying the vehicle 104 and/or the towable object 106 at block 212, and/or estimating a towing experience level of the user at block 212. As an example, the chatbot 118 may receive a user query at block 208, and can generate corresponding output that responds to the user query at block 210. As another example, the chatbot 118 may generate and output a question for the user at block 210, and can receive a corresponding answer from the user at block 208. During the conversation, the chatbot 118 may provide the user with general towing-related information, such as general towing safety tips. However, the chatbot 118 may also provide the user with more specific and/or customized towing-related information, for instance based upon the identities of the vehicle 104 and/or the towable object 106, corresponding manufacturer data 122, insurance policy data 126 indicating whether towing of the towable object 106 by the vehicle 104 is covered by an insurance policy, steering and driving data, and/or other information.

As discussed above, the chatbot 118 may be based upon a GPT model or other generative AI system that can interpret natural language user input 108 and/or generate natural language output during the conversation. Accordingly, the user may converse with the chatbot 118 naturally by asking free-form questions or making other natural language statements at block 208, and receiving corresponding natural language responses that are generated by the chatbot 118 at block 210 instead of, or in addition to, receiving prewritten responses or predetermined information. In some examples, the chatbot 118 may also cause the smart towing assistant 102 to present how-to videos or other types of media to the user proactively and/or in response to user input 108 instead of, or in addition to, generating natural language output.

As noted, in some embodiments, the voice bots or chatbots 118 discussed herein may be configured to utilize AI (artificial intelligence) and/or ML (machine learning) techniques. For instance, the chatbot 118 may be a large language model such as OpenAI GPT-4, Meta LLaMa, or Google PaML 2. The voice bot or chatbot 118 may employ supervised or unsupervised ML techniques, which may be followed by, and/or used in conjunction with, reinforced or reinforcement learning techniques. The voice bot or chatbot 118 may employ the techniques utilized for ChatGPT.

At block 212, the chatbot 118 may identify the vehicle 104 and/or the towable object 106, such that the chatbot 118 can provide towing-related safety information, towing-related insurance information, and/or other towing-related information that is specific to the make, model, and/or type of the vehicle 104 and/or the towable object 106 during the towing-related conversation. For example, the chatbot 118 may provide towing-related safety information related to the specific vehicle 104 and/or the specific towable object 106 during the conversation, based upon corresponding manufacturer data 122 that indicates attributes of the specific vehicle 104 and/or the specific towable object 106.

In some examples, the user may provide a text description, a photograph, or other information to the chatbot 118 during the towing-related conversation, such that the chatbot 118 can identify the vehicle 104 and/or the towable object 106 based upon the user-provided conversation. In other examples, the chatbot 118 may identify the vehicle 104 and/or the towable object 106 based upon other information that is not directly provided by the user during the conversation. For instance, if the user is a policyholder of an insurance company, the chatbot 118 may use insurance policy data 126 associated with the policyholder to look up the identity of the vehicle 104 and/or the towable object 106.

At block 214, the chatbot 118 may estimate a towing experience level of the user based upon user input 108 provided during the conversation and/or based upon other information. For example, questions asked by the user during the conversation, and/or user answers to towing-related questions posed by the chatbot 118, may indicate that the user is relatively unfamiliar with towing. Accordingly, the chatbot 118 may generate output during the conversation at block 210 based at least in part on the estimated the towing experience level of the user. For example, if the estimated the towing experience level of the user is relatively low, the chatbot 118 may be more likely to present towing-related safety information, how-to videos, towing preparation checklists, and/or other towing-related information to the user relative to if the user has demonstrated familiarity with towing-related topics.

User input 108 received at block 208 may be a user inquiry about whether towing of the towable object 106 by the vehicle 104 is covered by an insurance policy, and the chatbot 118 may use insurance policy data 126 to generate a corresponding answer to that user inquiry. However, the chatbot 118 may also determine, at block 214, whether the user is requesting to a change to towing insurance coverage, for instance to add or adjust towing coverage in association with an insurance policy.

If the user has not requested a change to towing insurance coverage during the conversation (Block 214—No), the conversation can continue at block 206. However, if the user has requested a change to towing insurance coverage during the conversation (Block 214—Yes), the chatbot 118 or other elements of the smart towing assistant 102 can at least initiate the change to the towing insurance coverage at block 216 before returning to the conversation.

For example, at block 216 the chatbot 118 or other elements of the smart towing assistant 102 may generate a quote for adding towing insurance coverage to the user's insurance policy, or for changing existing towing insurance coverage associated with the user's insurance policy, or may request that such a quote be generated by a separate system. The chatbot 118 may accordingly present the generated quote to the user during the conversation. In some examples, the user may provide user input 108 during the conversation indicating that the user accepts the quote, and the chatbot 118 or other elements of the smart towing assistant 102 can accordingly transmit information that causes the quote to be accepted and/or corresponding changes to the user's insurance policy to be made in the insurance policy data 126.

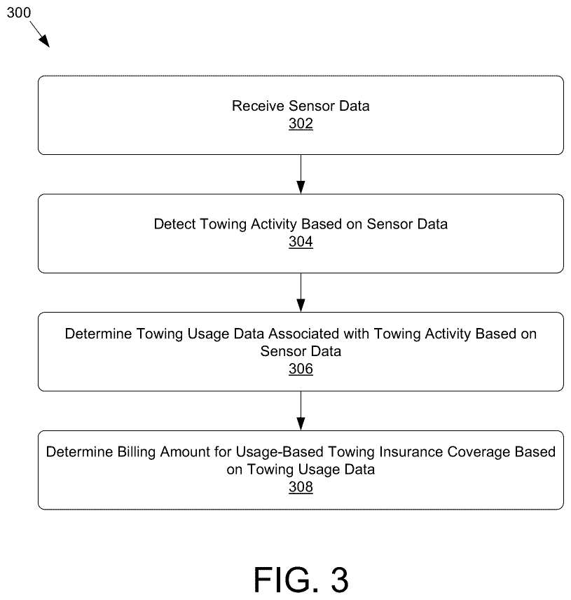

Overall, the chatbot 118 can be trained and deployed to provide towing-related information to a user before and/or during towing activity, including towing safety information and towing insurance information. Providing such information can educate the user about towing-related topics, and accordingly reduce the likelihood of towing-related accidents and/or towing-related insurance claims that are submitted to an insurance company. Other aspects related to towing insurance are discussed further below with respect to FIG. 3.

### Exemplary Usage-Based Towing Insurance

FIG. 3 shows a flowchart illustrating an exemplary computer-implemented method 300 for implementing usage-based towing insurance coverage based upon sensor data 110. The method 300 shown in FIG. 3 may be performed by one or more computing systems, such as a computing system that executes the smart towing assistant 102 and/or a computing system that executes the usage-based insurance system 132. An exemplary system architecture for such a computing system is described below with respect to FIG. 5.

At block 302, the smart towing assistant 102 or the usage-based insurance system 132 may receive sensor data 110 captured by one or more sensors 114 associated with the vehicle 104 and/or the towable object 106. In some examples, the sensors 114 may be permanently incorporated into the vehicle 104 and/or the towable object 106. In other examples, the sensors 114 may be part of a user device or other hardware device that is at least temporarily present on or within the vehicle 104 and/or the towable object 106.

At block 304, an instance of the towing detector 128 associated with the smart towing assistant 102 or the usage-based insurance system 132 may detect, based upon the sensor data 110, an instance of towing activity. As an example, the sensor data 110 may include motion data collected by an accelerometer, and the towing detector 128 can compare the motion data to a baseline profile associated with non-towing activity of the vehicle 104. If the motion data indicates that the vehicle 104 is accelerating and/or braking more slowly than would be expected based upon the baseline profile, is taking corners differently than would be expected based upon the baseline profile, and/or otherwise differs from the baseline profile, the towing detector 128 can determine that the vehicle 104 is likely engaged in towing activity. As another example, the sensor data 110 may indicate that a physical, electrical, and/or data connection has been made to attach the towable object 106 to the vehicle 104 in preparation for towing, and the towing detector 128 can accordingly determine that the vehicle 104 is or will be engaged in towing activity.

At block 306, the smart towing assistant 102 or the usage-based insurance system 132 may also use the sensor data 110 to determine towing usage data 130 associated with the detected towing activity. For example, time data, GPS data, and/or other information in the sensor data 110 may indicate a start time of the towing activity, an end time of the towing activity, an overall duration of the towing activity, a route traveled by the vehicle 104 during the towing activity, a distance traveled by the vehicle 104 during the towing activity, and/or other types of towing usage data 130.

At block 308, the usage-based insurance system 132 may use the towing usage data 130 to determine a billing amount for corresponding usage-based towing insurance coverage. For example, the usage-based insurance system 132 can use the towing usage data 130 to determine a billing amount, and/or a billing discount, associated with a billing period based upon towing usage data 130 that corresponds to instances of towing activity that occurred during the billing period. In some examples, the usage-based insurance system 132 may also use other information, such as traffic data, weather data, visibility data, and/or other data to determine, in combination with the towing usage data 130 to determine risk levels of the instances of towing activity that occurred during the billing period, and determine the billing amount based at least in part on the determined risk levels of the instances of towing activity.

### Exemplary Safety Issue Determination

FIG. 4 shows a flowchart illustrating an exemplary computer-implemented method 400 for providing alerts to a driver of the vehicle 104 when sensor data 110 indicates a safety issue associated with towing of the towable object 106 by the vehicle 104. The method 400 shown in FIG. 4 may be performed by one or more computing systems, such as a computing system on-board the vehicle 104 that executes the towing lane assist system 134 independently or as a part of the smart towing assistant 102. An exemplary computer system architecture for such a computing system is described below with respect to FIG. 5.

At block 402, the towing lane assist system 134 may receive sensor data 110 during towing of the towable object 106 with the vehicle 104. The sensor data 110 received at block 402 may include image data, proximity data, and/or other information. For example, the sensor data 110 may include image data captured by cameras that are permanently or temporarily mounted on the vehicle 104 and/or the towable object 106, such as forward-facing, side-facing, and/or rear-facing cameras that capture images of the environment surrounding the towable object 106.

At block 404, the towing lane assist system 134 may determine whether the sensor data 110 received at block 402 is indicative of a towing-related safety issue. For example, the towing lane assist system 134 may image processing techniques to, based upon image data provided by one or more cameras, identify a position of the towable object 106 relative to lane markings, other portions of a road, vehicles, and/or other objects. The towing lane assist system 134 may also analyze such image data to determine if the towable object 106 is at risk of veering into a different lane during a period of time in which the driver has not signaled a lane change, or is at risk of impacting another object during a planned or unplanned lane change, while turning a corner, or during other situations.

As an example, the towing lane assist system 134 can detect a towing-related safety issue if an analysis of image data indicates that a distance between the side of the towable object 106 and lane markings has decreased to below a threshold distance, and the driver has not used turn signals to indicate that the driver intends to cross the lane markings as part of a lane change. As another example, the towing lane assist system 134 can be configured to detect a towing-related safety issue if a current or expected trajectory of the towable object 106 during lane changes, cornering, and/or other driving operations, indicated by an analysis of image data, indicates that the towable object 106 has at least a threshold likelihood of causing the towable object 106 to impact other vehicles or objects, drive off a road, or otherwise lead to other negative situations. Examples of the towing lane assist system 134 detecting towing-related safety issues, which may occur in association with block 404, are discussed further below with respect to FIG. 7 and FIG. 8.

If the sensor data 110 received at block 402 is not indicative of a towing- related safety issue (Block 404—No), the towing lane assist system 134 may continue receiving additional sensor data 110 at block 402 so that the towing lane assist system 134 can determine whether the additional sensor data 110 is indicative of a towing-related safety issue at block 404. However, if the sensor data 110 received at block 402 is indicative of a towing-related safety issue (Block 404—Yes), the towing lane assist system 134 may cause a corresponding alert to be output at block 406.

The alert may be an audible alert, visual alert, haptic feedback alert, and/or other type of alert such that the driver of the vehicle 104 can be made aware of the towing-related safety issue. The driver can potentially take action to avoid an imminent collision or another towing-related safety issue in response to the alert, such that the likelihood of a collision or other negative event can be reduced. Accordingly, such alerts may reduce the number of towing-related accidents and/or a number of towing-related insurance claims that are submitted to an insurance company.

### Exemplary Computer System Architecture

FIG. 5 shows an exemplary system architecture 500 for a computing system 502 that can execute one or more elements associated with the smart towing assistant 102, the model training system 120, the usage-based insurance system 132, and/or other elements described herein. In some examples, the computing system 502 may be a user device, such a smartphone or computer. In other examples, the computing system 502 may be an on-board computing system of the vehicle 104, such as a computing system that executes a dashboard system of the vehicle 104 and/or other systems of the vehicle 104. In still other examples, the computing system 502 may be a server or element of a cloud computing system that is separate and/or remote from a user device or the vehicle 104. The computing system 502 may include one or more computers, servers, or other types of computing devices. Individual computing devices of the computing system 502 may have the system architecture 500 shown in FIG. 5, or a similar system architecture.

In some examples, elements of the smart towing assistant 102, the model training system 120, the usage-based insurance system 132, and/or other elements described herein can be distributed among, and/or be executed by, multiple computing systems or devices similar to the computing system 502 shown in FIG. 5. As an example, frontend elements of the smart towing assistant 102 may be executed by a user device and/or a dashboard system of the vehicle, while backend elements of the smart towing assistant 102 may be executed by one or more remote servers and/or elements of a cloud computing environment. As another example, the model training system 120 and/or usage-based insurance system 132 may be executed via one or more computing systems that are different from one or more computing systems that execute the smart towing assistant 102.

The computing system 502 can include memory 504. In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 502. Any such non-transitory computer-readable media may be part of the computing system 502.

The memory 504 can store modules and data 506, including software or firmware elements, such as data and/or computer-readable instructions that are executable by one or more processors 508. For example, the memory 504 can store computer-executable instructions and data associated with one or more elements of the smart towing assistant 102, such as the user interface 116, the chatbot 118, the towing detector 128, and/or the towing lane assist system 134. As another example, the memory 504 can store computer-executable instructions and data associated with the model training system 120. As yet another example, the memory 504 can store computer-executable instructions and data associated with the usage-based insurance system 132.

The modules and data 506 stored in the memory 504 can also include any other modules and/or data that can be utilized by the computing system 502 to perform or enable performing any action taken by the computing system 502. Such modules and data 506 can include a platform, operating system, and applications, and data utilized by the platform, operating system, and applications.

The computing system 502 may also have processor(s) 508, communication interfaces 510, a display 512, output devices 514, input devices 516, and/or a drive unit 518 including a machine readable medium 520.

In various examples, the processor(s) 508 can be a central processing unit (CPU), a graphics processing unit (GPU), both a CPU and a GPU, or any other type of processing unit. Each of the one or more processor(s) 508 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 508 may also be responsible for executing computer applications stored in the memory 504, which can be associated with types of volatile (RAM) and/or nonvolatile (ROM) memory.

The communication interfaces 510 can include transceivers, modems, network interfaces, antennas, and/or other components that can transmit and/or receive data over networks or other connections. The communication interfaces 510 can be used to exchange data between elements described herein. For instance, in some examples, the communication interfaces 510 can receive user input 108 and/or sensor data 110, transmit or receive towing usage data 130, and/or access manufacturer data 122, towing safety information 124, insurance policy data 126, and/or other types of information.

The display 512 can be a liquid crystal display, or any other type of display used in computing devices. In some examples, the display 512 can be a screen or other display of a dashboard system of the vehicle 104, or of a user device. The output devices 514 can include any sort of output devices known in the art, such as the display 512, speakers, a vibrating mechanism, and/or a tactile feedback mechanism. Output devices 514 can also include ports for one or more peripheral devices, such as peripheral speakers and/or a peripheral display. In some examples, output of the chatbot 118 and/or alerts output by the towing lane assist system 134 can be presented via the display 512 and/or the output devices 514.

The input devices 516 can include any sort of input devices known in the art. For example, input devices 516 can include a microphone, a keyboard/keypad, and/or a touch-sensitive display, such as a touch-sensitive display screen. A keyboard/keypad can be a push button numeric dialing pad, a multi-key keyboard, or one or more other types of keys or buttons, and can also include a joystick-like controller, designated navigation buttons, or any other type of input mechanism. In some examples, the user input 108 can be provided via the input devices 516. In some examples, the input devices 516 may also, or alternately, include the sensors 114, such that sensor data 110 can be provided via the input devices 516.

The machine readable medium 520 can store one or more sets of instructions, such as software or firmware, that embodies any one or more of the methodologies or functions described herein. The instructions can also reside, completely or at least partially, within the memory 504, processor(s) 508, and/or communication interface(s) 510 during execution thereof by the computing system 502. The memory 504 and the processor(s) 508 also can constitute machine readable media 520.

Although the subject matter has been described in language specific to structural features and/or methodological acts, it is to be understood that the subject matter is not necessarily limited to the specific features or acts described above. Rather, the specific features and acts described above are disclosed as example embodiments.

### Exemplary Embodiments

In one aspect, a computer-implemented method may interact with a user via a smart towing assistant and/or an associated chatbot. The method may include (1) providing, by a computing system comprising one or more processors, a smart towing assistant comprising a chatbot, wherein the chatbot is trained, based upon a training dataset, to engage in a conversation with a user in association with towing of a towable object by a vehicle; (2) receiving, by the computing system, and via the chatbot during the conversation, user input comprising natural language input; (3) generating, by the computing system, and via the chatbot, output based at least in part on the user input, wherein the output comprises natural language output that expresses towing-related information; and/or (4) presenting, by the computing system, and via the chatbot, the output during the conversation. The method may include additional, less, or alternate functionality, including that discussed elsewhere herein.

For instance, the chatbot may be a generative pre-trained transformer (GPT) model trained on the training dataset. The training dataset may include (i) manufacturer data indicating attributes of vehicles and towable objects; (ii) towing safety information approved by an insurance company; (iii) driving information, instructions, or directions; (iv) steering information, instructions, or directions; and/or (v) insurance policy information associated with a set of insurance policies provided by the insurance company.

The method may also include determining, by the computing system, an identity of at least one of the vehicle or the towable object. The chatbot may generate the output based at least in part on the identity of the at least one of the vehicle or the towable object. The output may express towing-related safety information based at least in part on attributes of the at least one of the vehicle or the towable object indicated by manufacturer data. The computing system may determine the identity of at least one of the vehicle or the towable object based upon at least one of: a user-provided description, image analysis of a user- provided photograph of the at least one of the vehicle or the towable object, or insurance policy information associated with the at least one of the vehicle or the towable object.

The method may include estimating, by the computing system, a towing experience level of the user based at least in part on the user input received during the conversation. The chatbot may generate the output based at least in part on the towing experience level of the user. Additionally or alternatively, the output may express towing insurance coverage information indicating whether an insurance policy covers the towing of the towable object by the vehicle.

The method may include determining, by the computing system, that the user input requests a change to an insurance policy to adjust towing insurance coverage; and initiating, by the computing system, the change to the insurance policy based upon the user input.

The method may also include (i) receiving, by the computing system, sensor data associated with the towing of the towable object by the vehicle; (ii) detecting, by the computing system, an instance of towing activity based upon the sensor data; and/or (iii) providing, by the computing system, towing usage data associated with the instance of towing activity to a usage-based insurance system. The usage-based insurance (UBI) system may be configured to determine a billing amount for usage-based towing insurance based at least in part on the towing usage data.

The method may also include (i) receiving, by the computing system, image data indicative of an environment surrounding the towable object during the towing of the towable object by the vehicle; (ii) determining, by the computing system, and based upon the image data, at least one of: a distance between the towable object and lane markings decreasing below a threshold distance, or a trajectory of the towable object having at least a threshold likelihood of causing the towable object to collide with another object; and/or (iii) generating, providing, or outputting, by the computing system, an alert that indicates a towing-related safety issue to the user or a driver of the vehicle.

In another aspect, a computer system for interacting with a user via a smart towing assistant and/or associated chatbot or voice bot may be provided. The computer system may include one or more processors, and memory storing computer-executable instructions that, when executed by the one or more processors, cause the one or more processors to: (1) receive, via a chatbot trained on a training dataset, and during a conversation associated with towing of a towable object by a vehicle, user input comprising natural language input; (2) generate, via the chatbot, output based at least in part on the user input, wherein the output comprises natural language output that expresses towing-related information; and/or (3) present, via the chatbot, the output during the conversation. The system may include additional, less, or alternate functionality, including that discussed elsewhere herein.

In another aspect, a computer-executable towing lane assist system may alert a driver of a vehicle to one or more safety issues associated with towing of a towable object by the vehicle. The computer-executable towing lane assist system may be implemented via one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another. The system may include a sensor mounted on a towable object towed by a vehicle, and a computer-executable towing lane assist system. The computer-executable towing lane assist system may be configured to (1) receive sensor data captured by the sensor; (2) determine, based upon the sensor data, a position of the towable object relative to an element in an environment surrounding the towable object; (3) detect, based upon the position of the towable object relative to the element, a safety issue associated with towing of the towable object by the vehicle; and/or (4) output a safety alert configured to inform a driver of the vehicle of the safety issue. The computer-executable towing lane assist system may be configured to execute additional, less, or alternate functionality, including that discussed elsewhere herein.

In some aspects, the computer-executable towing lane assist system may (i) determine the position of the towable object relative to the element by detecting a distance between the towable object and the element, and/or (ii) detect the safety issue by determining that the distance is less than a threshold distance. As an example, the element may include lane markings indicating an edge of a lane traveled by the vehicle and the towable object, and the distance may be a lane marking distance between the towable object and the edge of the lane. In certain aspects, the computer-executable towing lane assist system may be configured to output the safety alert based upon determining that the lane marking distance is less than the threshold distance, and that a turn indicator of the vehicle is not active. As another example, the element may be an external object separate from the towable object and the vehicle, and the distance may be an external object distance between the towable object and the external object.

In some aspects, the element may be an external object separate from the towable object and the vehicle. The computer-executable towing lane assist system may (i) determine the position of the towable object relative to the element by detecting a travel trajectory of the towable object relative to at least one of a position or a trajectory of the external object, and/or (ii) detect the safety issue by determining that the travel trajectory of the towable object has at least a threshold likely of causing the towable object to, based upon the at least one of the position or the trajectory of the external object, collide with the external object.

In certain aspects, the sensor may be a camera, and/or the sensor data may be image data depicting the environment surrounding the towable object. In some aspects, the computer-executable towing lane assist system may be executed via an on-board computing system of the vehicle. Additionally or alternatively, the safety alert may include at least one of an audible alert, a visual alert, or a haptic feedback alert.

In another aspect, a computer-implemented method may alert a driver of a vehicle regarding safety issues related to towing a towable object with a vehicle. The computer-implemented method may be implemented via one or more local or remote processors, servers, transceivers, memory units, mobile devices, user devices, computing devices, voice bots or chatbots, ChatGPT or ChatGPT-based bots, and/or other electronic or electrical components, which may be in wired or wireless communication with one another. For instance, in one embodiment, the method may include (1) receiving, by a computing system including one or more processors, sensor data captured by at least one sensor mounted on a towable object being towed by a vehicle; (2) determining, by the computing system, and based upon the sensor data, a position of the towable object relative to an element in an environment surrounding the towable object; (3) detecting, by the computing system, and based upon the position of the towable object relative to the element, a safety issue associated with towing of the towable object by the vehicle; and/or (4) outputting, by the computing system, a safety alert configured to inform a driver of the vehicle of the safety issue. The method may include additional, less, or alternate functionality, including that discussed elsewhere herein.

In another aspect, one or more non-transitory computer-readable media storing computer-executable instructions associated with a towing lane assist system may be provided. The computer-executable instructions, when executed by one or more processors of a computing system, may cause the one or more processors (and/or associated transceivers) to: (1) receive sensor data captured by at least one sensor mounted on a towable object being towed by a vehicle; (2) determine, based upon the sensor data, a position of the towable object relative to an element in an environment surrounding the towable object; (3) detect, based upon the position of the towable object relative to the element, a safety issue associated with towing of the towable object by the vehicle; and/or (4) output a safety alert configured to inform a driver of the vehicle of the safety issue (such as generate a visual, textual, verbal, audible, graphical, or other output). The computer-executable instructions may provide additional, less, or alternate functionality, including that discussed elsewhere herein.

### Exemplary Driver Assistance Embodiments

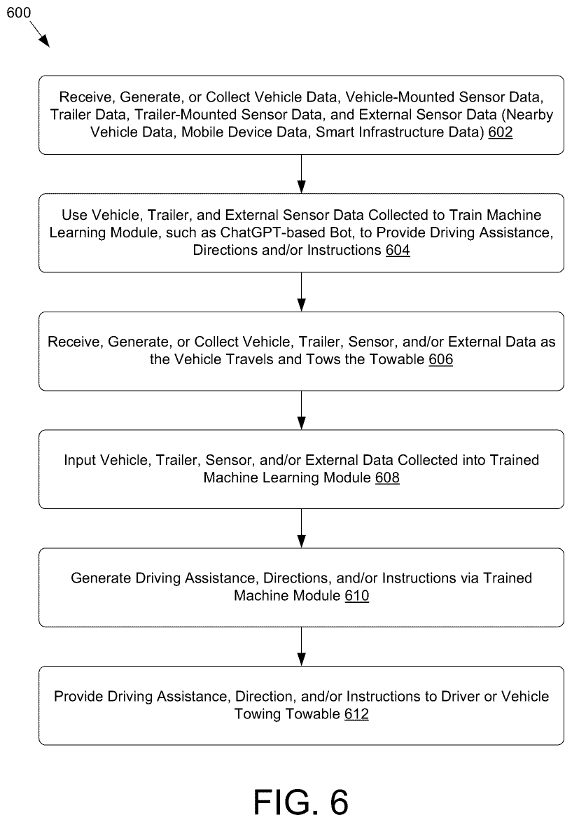

FIG. 6 depicts an exemplary computer-implemented method 600 of providing driving assistance and/or instructions while towing a towable. The method may be implemented via one or more local or remote processors, servers, transceivers, sensors (including cameras), memory units, mobile devices, wearables, smart vehicles, smart towables or trailers, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another.

The method 600 may include, via one or more local or remote processors and/or associated transceivers and sensors, receiving, generating, and/or collecting sensor and other data 602 discussed herein, including that further below. For instance, vehicle data, vehicle-mounted sensor data, trailer sensor data, trailer-mounted sensor data, and external sensor data. The external sensor data may include mobile device data, other vehicle data, smart infrastructure data, and/or other data wirelessly transmitted over one or more radio frequency links.

The method 600 may include, via one or more local or remote processors, inputting the sensor data, such as vehicle and/or trailer data, external data, and other data into a machine learning module to train the module 604. For instance, the module may be trained to provide driving assistance, directions, and/or instructions for drivers of vehicles that are towing towables, or for self-driving vehicles that are towing towables. The driver assistance may include lane assistance, parking assistance, backing up assistance, and other assistance discussed elsewhere herein.

The method 600 may include, via one or more local or remote processors and/or associated transceivers and sensors, receiving, collecting, or generating real-time or near real-time sensor data (including vehicle and trailer data, vehicle-mounted sensor data, and/or trailer-mounted sensor data) and real-time or near real-time external data 606. For instance, the sensor data and external data may include the types of data discussed elsewhere herein.

The method 600 may include, via one or more local or remote processors, inputting the sensor and/or external sensor data into the trained machine learning module 608. For instance, the machine learning module may be trained to generate driving directions and/or instructions based upon sensor and/or external sensor data.

The method 600 may include, via one or more local or remote processors and/or the trained machine learning module, generating driving directions and/or instructions for drivers (and/or vehicles) that are towing towables 610, such as trailers.

The method 600 may include, via one or more local or remote processors and/or user interface devices, providing the driving directions and/or instructions to the driver of a vehicle towing a towable or trailer, or to a semi-autonomous or autonomous vehicle 612 operating in self-driving mode. The method may include additional, less, or alternate functionality, including that discussed elsewhere herein.

In one aspect, a computer-implemented method for providing driving assistance and/or driving instructions is provided. The method may be implemented via one or more local or remote processors, servers, transceivers, sensors (including cameras), memory units, mobile devices, wearables, smart watches, smart vehicles, smart towables or trailers, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. In one instance, the method may include (1) inputting sensor data into a generative AI model trained to provide driving assistance, directions, instructions, and/or indicators for a vehicle towing a trailer based upon, inter alia, the sensor data; (2) generating, via the trained generative AI, the driving assistance, directions, instructions, and/or indicators for the vehicle towing the trailer (based upon the sensor data); and/or (3) providing, via the trained generative AI model and/or an associated user interface (or user interface tool/device, such as AR glasses), the driving assistance, directions, instructions, and/or indicators for the vehicle towing the trailer to (i) a driver of the vehicle that is driving the vehicle, and/or (ii) the vehicle towing the trailer (such as in the case of semi-autonomous or autonomous vehicle) to facilitate providing driving assistance and/or driving instructions to drivers and/or vehicles. The method may include additional, less, or alternate functionality, including that discussed elsewhere herein.

For instance, the associated user interface tool/device may include a chatbot or voice bot, and the driving assistance, directions, instructions, and/or indicators may include audible or verbal assistance, directions or instructions. Additionally or alternatively, the associated user interface tool/device may include a display screen, and the driving assistance, directions, instructions, and/or indicators may include visuals, graphics, holograms, text, and/or textual directions/instructions that are displayed upon the display screen or projected onto a surface/window. Additionally or alternatively, the associated user interface tool/device comprises AR (Augmented Reality) glasses, and the driving assistance, directions, instructions, and/or indicators may include visuals, graphics, icons, text, and/or textual assistance, directions, instructions, and/or indicators that are displayed via the AR glasses (such as visuals or graphics overlaid upon actual images of a road, parking lot, road, turn, intersection, parking spot, camp site, park, etc.).

The sensor data may include sensor data (including audio data, image data, GPS data, vehicle telematics data (such as acceleration, braking, route, heading, speed, lane, road, and cornering data), lane marker/marking data, etc.) that is generated and/or collected from one or more sources, including (i) the vehicle towing the trailer; (ii) other vehicles on the road (such as other vehicle data received via V2V (vehicle-to-vehicle) wireless communication) in the vicinity; (iii) smart infrastructure data (such as smart street sign data received via V2x wireless communication); (iv) aerial devices (such as plane, drone, or satellite data received via wireless communication); (v) mobile devices of the driver or passengers within the vehicle or other nearby vehicles; and/or (vi) other sources.

The sensor data may include sensor data collected or generated by (i) the vehicle towing the trailer, such as if the vehicle is a smart vehicle, or semi-autonomous or autonomous vehicle; and/or (ii) by the trailer, such as if the trailer is a smart trailer or otherwise is equipped with processors, transceivers, and/or sensors (including cameras). The sensor data may be generated and/or collected by one or more processors while the driver is driving the vehicle as the vehicle is towing the trailer to provide the generative AI model with data that reflects how the vehicle handles while (i) towing the trailer, and (ii) being driven by that particular driver.

The computer-implemented method may also include (i) inputting GPS, road and/or route data into the generative AI model trained to provide driving assistance, directions, instructions, and/or indicators for a vehicle towing a trailer based upon the GPS, road and/or route data in addition to the sensor data; and/or (ii) generating and/or presenting, via the trained generative AI, driving assistance, directions, instructions, and/or indicators for the vehicle towing the trailer based upon the GPS, road and/or route data in addition to the sensor data.

Additionally or alternatively, the method may also include (1) building or generating, via one or more processors, a virtual travel environment surrounding the vehicle (such as in real-time or near real-time) based upon the sensor data received, collected, or generated; (2) inputting the virtual travel environment into the generative AI model trained to provide driving assistance, directions, instructions, and/or indicators for a vehicle towing a trailer based upon the virtual travel environment in addition to the sensor data; and/or (3) generating, via the trained generative AI, driving assistance, directions, instructions, and/or indicators for the vehicle towing the trailer (such as in real-time) based upon the virtual travel environment in addition to the sensor data. Additionally or alternatively, the virtual travel environment may include the direction, heading, GPS location, lane of travel, and speed of travel of other vehicles in the vicinity of and/or surrounding the vehicle towing the trailer. The driving assistance may facilitate parking, lane changes, turns, cornering, handling intersections, backing up, parking or traversing camp sites, etc.

The generative AI model may be trained to know how that particular vehicle travels or handles with that particular trailer while traveling on a particular road or road surface. The driving assistance, directions, instructions, and/or indicators may provide steering directions of when to turn and how much to turn the steering wheel (and thus the vehicle) to facilitate keeping the vehicle in the correct lane while turning. The driving assistance, directions, instructions, and/or indicators may be provided in verbal or audible format and/or visual, graphical, or textual format to the driver via the user interface or the user interface tool/device.

In another aspect, a computer system configured to provide driving assistance and/or driving instructions may be provided. The computer system may include one or more local or remote processors, servers, transceivers, sensors (including cameras), memory units, mobile devices, wearables, smart watches, smart vehicles, smart towables or trailers, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. In one instance, the computer system may include one or more processors and/or associated transceivers configured to: (i) receive, collect, or generate vehicle sensor data from sensors mounted on the vehicle and/or the trailer; (ii) receive external sensor data from one or more external sources (other vehicles, mobile devices, smart infrastructure, etc.) via wireless communication over one or more radio frequency links; (iii) input the vehicle sensor data and external sensor data into a generative AI model trained to provide driving assistance, directions, and/or instructions for driver or a vehicle towing a trailer based upon, inter alia, the vehicle sensor data and external sensor data; (iv) generate, via the trained generative AI, driving assistance, directions, instructions, and/or indicators for the vehicle towing the trailer (based upon the vehicle sensor data and external sensor data); and/or (v) provide, via the trained generative AI model and/or an associated user interface (or user interface tool/device), the driving assistance, directions, instructions, and/or indicators for the vehicle towing the trailer to (a) a driver of the vehicle that is driving the vehicle, or (b) the vehicle towing the trailer (such as in the case of semi-autonomous or autonomous vehicle) to facilitate providing driving assistance and/or driving instructions to drivers and/or vehicles. The computer system may include additional, less, or alternate functionality, including that discussed elsewhere herein.

For instance, the associated user interface or user interface tool/device may include a chatbot or voice bot, and the driving assistance, directions, instructions, and/or indicators may include audible or verbal directions and/or instructions. Additionally or alternatively, the associated user interface or user interface tool/device may include a display screen, and the driving assistance, directions, instructions, and/or indicators may include visuals, graphics, holograms, text, and/or textual assistance, directions, instructions, and/or indicators that are displayed upon the display screen.

The associated user interface and/or user interface tool/device may include AR (Augmented Reality) glasses, and the driving assistance, directions, instructions, and/or indicators comprise visuals, graphics, icons, text, and/or textual assistance, directions, and/or instructions that are displayed via the AR glasses (such as visuals or graphics overlaid upon actual images of a road, parking lot, etc.). The sensor data may include sensor data (including audio data, image data, GPS data, vehicle telematics data (such as acceleration, braking, cornering, speed, location, time of day, and route data), lane marker/marking data, etc.) that is generated and/or collected from one or more sources, including (i) the vehicle towing the trailer; (ii) other vehicles on the road (such as other vehicle data received via V2V (vehicle-to-vehicle) wireless communication) in the vicinity; (iii) smart infrastructure data (such as smart street sign or light data received via V2x wireless communication); (iv) aerial devices (such as plane, drone, or satellite data received via wireless communication); (v) mobile devices of the driver or passengers within the vehicle or other nearby vehicles; and/or (vi) other sources.

The sensor data may include sensor data collected or generated by (i) vehicle towing by the trailer, such as if the vehicle is a smart vehicle, or semi-autonomous or autonomous vehicle; and/or (ii) by the trailer, such as if the trailer is a smart trailer or otherwise is equipped with processors, transceivers, and/or sensors (including cameras). The sensor data may be collected while the driver is driving the vehicle as the vehicle is towing the trailer to provide the generative AI model with data that reflects how the vehicle handles while (i) towing that particular trailer, and (ii) being driven by that particular driver. Sensor data may also be collected to reflect how the vehicle tows the trailer or otherwise handles on specific roads or road types, such as dirt roads, city roads, or highways.

The computer system may be further configured to: (i) input GPS, road and/or route data into the generative AI model trained to provide driving assistance, directions, instructions, and/or indicators for a vehicle towing a trailer based upon the GPS, road and/or route data in addition to the sensor data; and/or (ii) generate, via the trained generative AI, driving assistance, directions, instructions, and/or indicators for the vehicle towing the trailer based upon the GPS, road and/or route data in addition to the sensor data. The driving assistance may facilitate parking, lane changes, turns, cornering, handling intersections, backing up, parking or traversing camp sites, etc.

The computer system may be further configured to: (i) build or generate, via one or more processors, a virtual travel environment surrounding the vehicle based the sensor data received, collected, or generated; (ii) input the virtual travel environment into the generative AI model trained to provide driving directions, instructions, and/or indicators for a vehicle towing a trailer based upon the virtual travel environment in addition to the sensor data; and/or (iii) generate, via the trained generative AI, driving directions, instructions, and/or indicators for the vehicle towing the trailer based upon the virtual travel environment in addition to the sensor data. Additionally, the virtual travel environment may include the direction of travel, location, lane and speed of travel of other vehicles in the vicinity of the vehicle towing the trailer. The generative AI model may be trained to know how that particular vehicle travels or handles with that particular trailer while traveling on a particular road, in a city, or on the interstate.

The driving assistance, directions, instructions, and/or indicators provide steering directions of when to turn and how much to turn a steering wheel of the vehicle to facilitate keeping the vehicle in the correct lane while turning, parking, changing lanes, moving through a campsite, etc. The driving directions, instructions, and/or indicators may be provided in verbal or audible format and/or visual, graphical, or textual format to the driver via user interface.

### Exemplary Towing Lane Assist Environment

FIG. 7 shows an exemplary computing environment 700 in which the towing lane assist system 134 can alert a driver of the vehicle 104 regarding towing-related safety issues while the vehicle 104 is towing the towable object 106. Such towing-related safety issues may, for example, be associated with the towable object 106 veering into a different lane and/or the towable object 106 being at risk of colliding with another vehicle or other object.

As described above with respect to FIG. 1, sensors 114 such as cameras, proximity sensors, and/or other types of sensors may be permanently or attached to the towable object 106. For instance, cameras and/or other types of sensors 114 may be built-in to the towable object 106 or may be separate or aftermarket elements that may be at least temporarily mounted, affixed, or otherwise installed on the towable object 106.

The sensors 114 may accordingly capture image data depicting the environment surrounding the towable object 106, such as still images, video images, infrared images, and/or other types of image data. The sensors 114 may also, or alternately, capture proximity sensor data, distance measurements, and/or other types of sensor data 110 associated with the environment surrounding the towable object 106. As an example, cameras may be mounted on one or more both sides of the towable object 106 to capture image data of the environment on one or both sides of the towable object 106. As another example, cameras may be mounted on the back of the towable object 106 to capture image data of the environment behind the towable object 106. In some examples, cameras or other sensors 114 on the vehicle 104, such as a backup camera of the vehicle 104, may also capture image data or other sensor data 110 associated with the environment surrounding the towable object 106.

The towing lane assist system 134 may be a computer-executable element that receives sensor data 110 from one or more sensors 114 on the towable object 106 and/or the vehicle 104. As described above, the towing lane assist system 134 may execute as an element of the smart towing assistant 102, or may execute as an independent element, via a computing system on-board the vehicle 104. In other examples, the towing lane assist system 134 may execute via a separate computing system, such as a user device or computing system on-board the towable object 106, but may interface with a computing system and/or user interface that is part of, and/or is within, the vehicle 104 such that the towing lane assist system 134 may output safety alerts that are perceivable by a driver of the vehicle 104.

The towing lane assist system 134 may receive image data, proximity sensor data, and/or other sensor data 110 from one or more sensors 114 as described above. The towing lane assist system 134 may use the sensor data 110 to detect elements within the environment surrounding the towable object 106. As an example, based upon image data captured by one or more cameras, the towing lane assist system 134 may use image processing techniques and/or object recognition techniques to recognize, within the image data, lane markings 702 that designate edges of a road lane along with the vehicle 104 and the towable object 106 are traveling. As another example, the towing lane assist system 134 may similarly use such techniques to recognize, within the image data, external objects 704 such as other vehicles, trees, buildings, road signs, and/or other objects.

Based upon recognizing lane markings 702, external objects 704, and/or other elements within the environment surrounding the towable object 106, the towing lane assist system 134 may also measure or estimate distances from the towable object 106 to such elements. For example, the towing lane assist system 134 may use image data to detect a position of lane markings 702 designating an edge of the road lane along with the vehicle 104 and the towable object 106 are traveling, relative to the position of the towable object 106. Accordingly, based upon the position of the lane markings 702 relative to the position of the towable object 106, the towing lane assist system 134 may measure or estimate a lane marking distance 706 between a side of the towable object 106 and the edge of the road lane. Similarly, the towing lane assist system 134 may use image data to detect a position of an external object 704, such as another vehicle, relative to the position of the towable object 106, and accordingly measure or estimate an external object distance 708 between a side of the towable object 106 and the position of the external object 704.

The towing lane assist system 134 may compare determined distances between the towable object 106 and other elements within the surrounding environment against corresponding threshold distances. The towing lane assist system 134 may generate and output a safety alert perceivable by a driver of the vehicle 104 if such distances are less than corresponding thresholds or have been decreasing and trending towards such corresponding thresholds.

As an example, if the towing lane assist system 134 determines that the lane marking distance 706 is less than a first threshold, and/or has been decreasing over a period of time and has decreased to less than the first threshold, the towing lane assist system 134 may determine that the towable object 106 is too close to an edge of the road lane being traveled by the vehicle 104 and the towable object 106 and/or is at risk of veering out of that road lane. Accordingly, the towing lane assist system 134 may output a safety alert to inform a driver of the vehicle 104 that the towable object 106 may be too close to the edge of the road lane and/or is at risk of veering out of the road lane. In some examples, the towing lane assist system 134 may communicate with, and/or be integrated with, a turn indicator system of the vehicle 104, such that the towing lane assist system 134 alerts the driver if the lane marking distance 706 decreases to below a threshold distance and the driver has not used turn signals to indicate that the driver intends to cross the lane markings 702 as part of a lane change.

As another example, if the towing lane assist system 134 determines that the external object distance 708 is less than a second threshold, and/or has been decreasing over a period of time and has decreased to less than the second threshold, the towing lane assist system 134 may determine that the towable object 106 is too close to the position of the external object 704 and/or is at risk of colliding with the external object 704. Accordingly, the towing lane assist system 134 may output a safety alert to inform a driver of the vehicle 104 that the towable object 106 may be too close to the external object 704 and/or is a risk of colliding with the external object 704.

In some examples, the towing lane assist system 134 may also be configured to use sensor data 110 to determine a current or expected trajectory of the towable object 106 while the towable object 106 is being towed by the vehicle 104, and to determine positions and/or trajectories of external objects 704. Accordingly, the towing lane assist system 134 may compare the current or expected trajectory of the towable object 106 with the position and/or trajectory of an external object 704 to determine if the current or expected trajectory of the towable object 106 has at least a threshold likelihood of leading to a collision with the external object 704, based upon the position and/or trajectory of an external object 704.

For example, the towing lane assist system 134 may use a series of images captured by cameras on the towable object 106 over a period of time to detect relative positions of surrounding environmental features, and use changes in the relative positions of the surrounding environmental features to determine whether the vehicle 104 and the towable object 106 are turning a corner, as well as a trajectory being taken by the vehicle 104 and/or the towable object 106 while turning the corner. Similarly, the towing lane assist system 134 may use such image data to detect positions and/or travel trajectories of external objects 704, such as other vehicles, over time.

If a comparison of the detected trajectory of the towable object 106 has at least a threshold likelihood of leading to a collision with an external object 704, based upon the position and/or trajectory of the external object 704, the towing lane assist system 134 may output a safety alert to inform a driver of the vehicle 104 of the risk of the towable object 106 colliding with the external object 704. For example, if the driver of the vehicle 104 turns a corner, and the travel trajectory of the towable object 106 during the turn has at least a threshold likelihood of causing the towable object 106 to collide with a stationary or moving external object 704, the towing lane assist system 134 may alert the driver such that the driver may alter the travel trajectory to reduce the chances of a collision.

As discussed above, the vehicle 104 may have a native lane assist system that can alert a driver if the vehicle 104 itself is unexpectedly veering into a different lane and/or would impact other objects during lane changes or other driving operations. However, such a native lane assist system may be configured based upon the dimensions of the vehicle 104 itself. The vehicle's native lane assist system may accordingly not be natively configured to account for the length and/or width of the towable object 106, and/or the combined dimensions of the vehicle 104 and the towable object 106 during towing. Accordingly, the towing lane assist system 134 can augment or replace the native lane assist system of the vehicle 104 when the vehicle 104 is towing the towable object 106.

FIG. 4, discussed above, shows a computer-implemented method by which the towing lane assist system 134 may provide alerts to a driver of the vehicle 104 when sensor data 110 indicates a safety issue associated with towing of the towable object 106 by the vehicle 104. FIG. 8, discussed below, also shows a computer-implemented method by which the towing lane assist system 134 may provide alerts to a driver of the vehicle 104 when sensor data 110 indicates a safety issue associated with towing of the towable object 106 by the vehicle 104.

### Exemplary Computer-Based Method for Detecting Safety Issues

FIG. 8 shows a flowchart illustrating an exemplary computer-implemented method 800 for providing alerts to a driver of the vehicle 104 when sensor data 110 indicates a safety issue associated with towing of the towable object 106 by the vehicle 104. The method 800 shown in FIG. 8 may be performed by one or more computing systems, such as a computing system on-board the vehicle 104 that executes the towing lane assist system 134 independently or as a part of the smart towing assistant 102. An exemplary computer system architecture for such a computing system is described above with respect to FIG. 5.

At block 802, the towing lane assist system 134 may receive sensor data 110 during towing of the towable object 106 with the vehicle 104. The sensor data 110 received at block 802 may include image data, proximity data, and/or other information. For example, the sensor data 110 may include image data captured by cameras that are permanently or temporarily mounted on the vehicle 104 and/or the towable object 106, such as forward-facing, side-facing, and/or rear-facing cameras that capture images of the environment surrounding the towable object 106.

At block 804, the towing lane assist system 134 may use the sensor data 110 to determine the lane marking distance 706 between the towable object 106 and an edge of a road lane being traveled by the vehicle 104 and the towable object 106. For example, as discussed above with respect to FIG. 7, the towing lane assist system 134 may use image processing techniques to, based upon image data provided by one or more cameras, recognize lane markings 702 depicted within the image data, and to measure or estimate the lane marking distance 706 between the towable object 106 and the lane markings 702.

At block 806, the towing lane assist system 134 may determine whether the lane marking distance 706 is below a threshold distance. If the lane marking distance 706 is below the threshold distance (Block 806—Yes), the towing lane assist system 134 may output a lane drift alert at block 808. The lane drift alert may be an audible alert, a visual alert, a haptic feedback alert, and/or other type of alert such that informs the driver of the vehicle 104 that the towable object 106 may be too close to the edge of the road lane and/or is at risk of veering out of the road lane.

In some examples, the towing lane assist system 134 may be configured to output the lane drift alert at block 808 if the lane marking distance 706 is below the threshold distance at a time when a turn indicator associated with the vehicle 104 and/or the towable object 106 has not been activated. For example, if the driver has activated a turn indicator to signal that the driver plans to make a lane change and move the vehicle 104 and the towable object 106 into an adjacent lane, the towing lane assist system 134 may be configured to avoid outputting the lane drift alert at block 808 even if the lane marking distance 706 drops below the threshold distance.

In addition to, or instead of, determining whether the lane marking distance 706 is below a threshold distance at block 804 and outputting a corresponding lane drift alert at block 806 in some situations if the lane marking distance 706 is below a threshold distance, the towing lane assist system 134 may also detect potential collisions between the towable object 106 and external objects 704 via blocks 810 through 816.

For example, at block 810, the towing lane assist system 134 may use the sensor data 110 to determine positions and/or trajectories of the towable object 106 and an external object 704. For example, as discussed above with respect to FIG. 7, the towing lane assist system 134 may use image processing techniques to, based upon image data provided by one or more cameras, recognize an external object 704 depicted within the image data, to determine relative positions of the vehicle 104 and the external object 704, and/or to measure or estimate an external object distance 708 between the towable object 106 and the external object 704. The towing lane assist system 134 may also use such image processing techniques to, based upon a series of images captured over a period of time, determine travel trajectories of the towable object 106 and/or the external object 704. For instance, the towing lane assist system 134 may determine that the towable object 106 and/or the external object 704 are turning, traveling straight, or traveling along other trajectories.

At block 812, the towing lane assist system 134 may determine a likelihood of a collision between the towable object 106 and the external object 704 based upon the positions and/or trajectories determined at block 810. As an example, if the towing lane assist system 134 determined relative positions of the towable object 106 and the external object 704, and accordingly determined the external object distance 708 between the towable object 106 and the external object 704, the towing lane assist system 134 may compare the external object distance 708 to a corresponding threshold distance. If the external object distance 708 is below the corresponding threshold distance, the towing lane assist system 134 may determine that the towable object 106 is too close to the external object 704 and/or has at least a threshold likelihood of colliding with the external object 704.

As another example, the towing lane assist system 134 may have determined a travel trajectory of the towable object 106. The towing lane assist system 134 may also determine whether the travel trajectory of the towable object 106 is likely to cause the towable object 106 to move within a threshold distance of a current position of a stationary external object 704, or a future position of the external object 704 based upon a detected travel trajectory of the external object 704. If the travel trajectory of the towable object 106 is likely to cause the towable object 106 to move within the threshold distance of the current or future position of the external object 704, the towing lane assist system 134 may determine that the towable object 106 has at least a threshold likelihood of colliding with the external object 704.

At block 814, the towing lane assist system 134 may determine whether the likelihood of a collision between the towable object 106 and the external object 704 is above a threshold likelihood. If the towing lane assist system 134 determines that the likelihood of a collision between the towable object 106 and the external object 704 is above the threshold likelihood (Block 814—Yes), the towing lane assist system 134 may output a potential collision alert at block 816. The potential collision alert may be an audible alert, a visual alert, a haptic feedback alert, and/or other type of alert such that informs the driver of the vehicle 104 that the towable object 106 may at risk of colliding with an external object. Accordingly, the driver may take action to avoid a potential or imminent collision between the towable object 106 and the external object 704 in response to the potential collision alert.

In some examples, the towing lane assist system 134 may be configured to output the potential collision alert at block 816 regardless of whether a turn indicator associated with the vehicle 104 and/or the towable object 106 has been activated. For example, the driver may have activated a turn indicator to signal that the driver plans to make a lane change and move the vehicle 104 and the towable object 106 into an adjacent lane, such that the towing lane assist system 134 may avoid outputting the lane drift alert at block 808. However, if the signaled lane change causes the external object distance 708 between the towable object 106 and an external object 704 to drop to less than a corresponding threshold distance and/or a travel trajectory of the towable object 106 during the lane change increases a likelihood of the towable object 106 colliding with the external object 704 during the lane change to higher than a threshold likelihood, the towing lane assist system 134 may output the potential collision alert at block 816 despite the driver having signaled the lane change.

The potential collision alert may accordingly alert the driver of a potential collision between the towable object 106 and the external object 704. For instance, the driver may have planned to make a lane change, but was not aware of the proximity between the towable object 106 and the external object 704 or the risk of the towable object 106 colliding with the external object 704 during the lane change. Accordingly, the potential collision alert may make the driver aware of such risks, so that the driver may cancel the lane change or take other actions to avoid a collision between the towable object 106 and the external object 704.

After outputting the lane drift alert at block 808, outputting the potential collision alert at block 816, or determining not to output either or both of the lane drift alert or the potential collision alert, the towing lane assist system 134 may return to block 802 to receive additional sensor data 110 that may be evaluated to detect potential safety issues associated with towing of the towable object 106. Accordingly, the towing lane assist system 134 may continuously or periodically monitor sensor data 110 throughout towing of the towable object 106 by the vehicle 104 to detect safety issues, such as the towable object 106 moving too close to lane markings 702 and/or external objects 704, and to output corresponding safety alerts to inform the driver of the vehicle 104 of the detected safety issues.

### Exemplary Towing Cornering Assist Environment

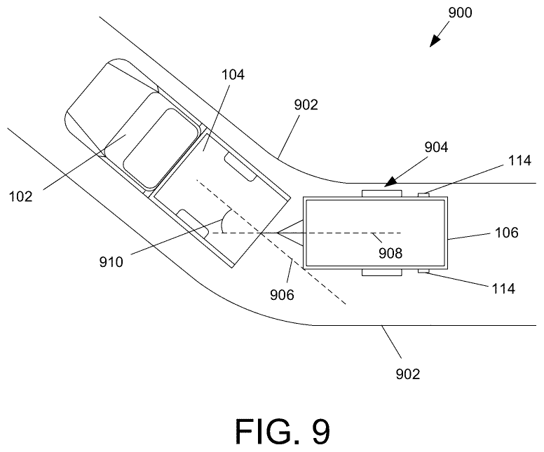

FIG. 9 shows an exemplary computing environment 900 in which the smart towing assistant 102 may assist a driver of the vehicle 104 in association with turning and/or cornering maneuvers while the vehicle 104 is towing the towable object 106. As described above, a driver of the vehicle 104 may not have experience with towing. Accordingly, the driver may not be familiar with how the vehicle 104 handles while towing the towable object 106, and/or may not be familiar with how the towable object 106 responds to movements of the vehicle 104. However, the smart towing assistant 102 may provide one or more outputs, or otherwise generate corrective actions, that assists the driver during towing of the towable object 106, such as (i) driving assistance or vehicle control assistance (i.e., engage autonomous or semi-autonomous technology systems or features to automatically drive the vehicle and towable object); (ii) determine and automatically take corrective actions for steering the vehicle; (iii) generate audible and/or visual alerts; (iv) automatically engage autonomous or self-driving features or systems; (v) display steering guidance on a screen or windshield, or provide other steering guidance, such as verbally or audibly; and/or (vi) safety tips or suggestions presented via the chatbot 118 and/or safety alerts triggered by the towing lane assist system 134.

As shown in FIG. 9, a driver of the vehicle 104 may perform turning and/or cornering maneuvers while driving the vehicle 104 connected to the towable object 106, for instance to follow a curve in a road; to turn from one road onto another road at an intersection; to turn in to or out of a parking lot; or for any other reason. Movements of the vehicle 104 during such turning and/or cornering maneuvers may cause corresponding movements of the towable object 106 being towed by the vehicle 104. However, in some situations the towable object 106 may move, relative to the vehicle 104 and/or elements in a surrounding environment, in a way that the driver does not expect or does not anticipate during turning and/or cornering maneuvers, for instance if the driver has relatively little experience with towing. However, as described herein, the smart towing assistant 102 may assist the driver with such turning and/or cornering maneuvers during towing of the towable object 106.

As discussed above, sensors 114 that are permanently or temporarily on the towable object 106 may capture image data, proximity sensor data, distance measurements, and/or other types of sensor data 110 associated with the environment surrounding the towable object 106. Cameras or other sensors 114 on the vehicle 104, such as a backup camera of the vehicle 104, may in some examples also capture image data or other sensor data 110 associated with the environment surrounding the towable object 106.

Elements of the smart towing assistant 102, such as the chatbot 118 and/or the towing lane assist system 134, that execute via a computing system may receive the sensor data 110 captured by sensors 114 on the vehicle 104 and/or the towable object 106. The computing system may, for example, be an on-board computing system of the vehicle 104, an on-board computing system of the towable object 106, a user device, and/or another computing device, including computing devices equipped with generative AI and/or voice bots. The elements of the smart towing assistant 102 may interface with a user interface that is part of, and/or is within, the vehicle 104, such that output of the smart towing assistant 102 may be perceived by a driver of the vehicle 104.

As an example, the smart towing assistant 102 may output a safety alert if the towing lane assist system 134 detects that the towable object 106 is at risk of veering out of a current travel lane, and/or may be at risk of colliding with another vehicle or other object, during a turning or cornering maneuver. The towing lane assist system 134 may use image data, proximity sensor data, GPS positioning data, map data, and/or other sensor data 110 to detect lane edges 902 of a road lane along which the vehicle 104 and the towable object 106 are traveling, and/or to detect other vehicles, objects, or features present within an environment surrounding the vehicle 104 and the towable object 106, for example as discussed above with respect to FIG. 7.

Based upon recognizing lane edges 902, and/or other elements within the environment surrounding the towable object 106, the towing lane assist system 134 may also measure or estimate distances from the towable object 106 to such elements. For example, the towing lane assist system 134 may use image data to detect a position of the lane edges 902 relative to the position of the towable object 106, and thereby measure or estimate a lane edge distance 904 between a side of the towable object 106 and the edge of the road lane.

The towing lane assist system 134 may compare determined distances between the towable object 106 and other elements within the surrounding environment against corresponding threshold distances. The towing lane assist system 134 may generate and output a safety alert perceivable by a driver of the vehicle 104 if, during a turning or cornering maneuver, such distances are less than corresponding thresholds or have been decreasing and trending towards such corresponding thresholds.

As an example, if during a turning or cornering maneuver the towing lane assist system 134 determines that the lane edge distance 904 is less than a threshold distance, and/or has been decreasing during a duration of the turning or cornering maneuver to less than the threshold distance, the towing lane assist system 134 may determine that the towable object 106 is too close to an edge of the road lane and/or is at risk of veering out of that road lane. Accordingly, the towing lane assist system 134 may generate and output a corrective action, such as a safety alert to inform a driver of the vehicle 104 that the towable object 106 may be too close to the edge of the road lane and/or is at risk of veering out of the road lane, such that the driver may adjust movements of the vehicle 104 and/or the towable object 106 during a remainder of the turning or cornering maneuver and/or following the turning or cornering maneuver. Additionally or alternatively, other corrective actions may be generated and output, such as (i) driving assistance or vehicle control assistance (i.e., engage autonomous or semi-autonomous technology systems or features to automatically drive the vehicle and towable object); (ii) determine and automatically take corrective actions for steering the vehicle; (iii) generate other audible and/or visual alerts; (iv) automatically engage autonomous or self-driving features or systems; (v) display steering guidance on a screen or windshield, or provide other steering guidance, such as verbally or audibly. For instance, the towing lane assist system 134 may use machine learning and/or generative AI techniques to determine control decisions for autonomous or semi-autonomous features or systems to take in order to maintain the vehicle 104 and towable object 106 within the road lane and from veering out of the road lane, such as during driving forward, cornering, maneuvering, and/or backing up.

For instance, the towing lane assist system 134 may also be configured to use sensor data 110 to determine a current or expected trajectory of the towable object 106 during a turning or cornering maneuver, and to determine corresponding positions and/or trajectories of other vehicles or objects, for example as discussed above with respect to FIG. 7. As an example, the towing lane assist system 134 may use a series of images captured by cameras on the vehicle 104 and/or the towable object 106 to identify relative positions of surrounding environmental features over time, and accordingly determine when a turning or cornering maneuver is occurring. The towing lane assist system 134 may also use such image data to determine a trajectory being taken by the vehicle 104 and/or the towable object 106 during the turning or cornering maneuver, as well as relative positions and/or travel trajectories of other objects or features. The towing lane assist system 134 may compare detected trajectories and/or relative positions of the towable object 106 and/or other elements to determine if the towable object 106 has at least a threshold likelihood of colliding with an external object during the turning or cornering maneuver, and if so may generate and output (i) a safety alert to that the driver may alter the travel trajectory of the vehicle 104 and/or the towable object 106 to reduce the chances of a collision, (ii) control decisions for autonomous or semi-autonomous vehicle features and technologies that alter the travel trajectory of the vehicle 104 and/or towable object 106 to reduce and prevent the odds of collision with other vehicles or objects; and/or (iii) other corrective actions discussed herein.

In some examples and for some corrective actions discussed herein, the towing lane assist system 134 may also, or alternately, use image data, proximity sensor data, compass data, GPS data, map data, positioning data, alignment data, directional data, and/or other types of sensor data 110 to identify a vehicle axis 906 along which the vehicle 104 is traveling and/or a towable object axis 908 along which the towable object 106 is traveling. The vehicle axis 906 and the towable object axis 908 may be directions oriented along respective lengths of the vehicle 104 and the towable object 106, and may indicate forward directions ahead of respective fronts of the vehicle 104 and the towable object 106. As an example, the towing lane assist system 134 may determine the vehicle axis 906 and the towable object axis 908 based upon compass data provided by sensors 114 on the vehicle 104 and the towable object 106 indicating respective orientations of the vehicle 104 and the towable object 106. As another example, the towing lane assist system 134 may use image data from a backup camera of the vehicle 104, depicting an orientation of the towable object 106 relative to a fixed orientation of the vehicle 104, and thereby determine the towable object axis 908 relative to the vehicle axis 906.

When the vehicle 104 and the towable object 106 are traveling along a straight line, such that the towable object 106 is traveling along the same direction as the vehicle 104, the vehicle axis 906 and the towable object axis 908 may be identical. However, during a turning or cornering maneuver, the vehicle axis 906 and the towable object axis 908 may be different as shown in FIG. 9.

If an angle 910 between the vehicle axis 906 and the towable object axis 908 exceeds a threshold angle during a turning or cornering maneuver, the angle 910 exceeding the threshold angle may be indicative of the vehicle 104 losing control of the towable object 106, the towable object 106 being at risk of veering out of the current road lane, and/or other safety issues. Accordingly, the towing lane assist system 134 may be configured to generate and output, if the towing lane assist system 134 determines that the angle 910 between the vehicle axis 906 and the towable object axis 908 exceeds the threshold angle during a turning or cornering maneuver, (i) a safety alert; (ii) control decisions for autonomous or semi-autonomous systems and features (such as to reduce the angle 910 to safe amount during a turning or cornering maneuver); and/or (iii) other corrective actions discussed herein.

In some examples and for some corrective actions discussed herein, the towing lane assist system 134 may also be configured to evaluate the angle 910 between the vehicle axis 906 and the towable object axis 908 at other times, for instance when the vehicle 104 and the towable object 106 are not engaged in a turning or cornering maneuver. For instance, the vehicle 104 is traveling straight along a straight road, and the angle 910 between the vehicle axis 906 and the towable object axis 908 exceeds the same or a different threshold value, or is changing over time, the angle 910 may indicate that the towable object 106 is not under control or is wobbling back and forth across a width of the travel lane due to a flat tire or other issue. The towing lane assist system 134 may be configured to generate and output a corresponding safety alert, driving assistance, driving control instructions to autonomous or semi-autonomous features or systems, and/or other corrective action in such situations.

In some situations, the chatbot 118 may also provide the driver of the vehicle 104 with safety tips and/or other information associated with turning or cornering maneuvers. As an example, if the towing lane assist system 134 determines that the lane edge distance 904 between the towable object 106 and lane edges 902 decreased to less than a threshold distance during multiple turns, the chatbot 118 may proactively generate and/or output natural language statements to inform the driver and/or to help the driver avoid that situation during future turns. For example, the chatbot 118 may generate natural language output such as “Hey, I noticed that the trailer was a little close to going outside the lane during the last few turns. Try to take future turns at a wider angle to avoid the risk of the trailer veering outside the lane.” In some examples, the chatbot 118 may output such safety tips or guidance even if the lane edge distance 904 did not decrease during previous turns to below a threshold value that prompts the towing lane assist system 134 to output a safety alert, in order to lower the chances of the towing lane assist system 134 having to output such safety alerts during future turns.

In some examples, elements of the smart towing assistant 102, such as the chatbot 118 and/or the towing lane assist system 134, may generate output based upon a machine learning model of turning or cornering maneuvers associated with the vehicle 104 and the towable object 106. The model training system 120 may generate such a machine learning model based upon training data indicating how the towable object 106 reacts to movements of the vehicle 104 during turning or cornering maneuvers. Accordingly, the smart towing assistant 102 may use the machine learning model to predict how the towable object 106 is likely to respond to movements of the vehicle 104 during current or future turning or cornering maneuvers.

The machine learning model of turning or cornering maneuvers may be based upon convolutional neural networks, fully-connected neural networks, other types of neural networks, nearest-neighbor algorithms, regression analysis, deep learning algorithms, Gradient Boosted Machines (GBMs), Random Forest algorithms, and/or other types of artificial intelligence or machine learning frameworks. The machine learning model can be trained on a set of training data, for instance using supervised machine learning, semi-supervised machine learning, or unsupervised machine learning.

The training data used to train the machine learning model may be based upon sensor data 110 associated with the vehicle 104 and the towable object 106 that has been captured over a period of time. The sensor data 110 may, for example, be historical data indicative of movements of the vehicle 104 and the towable object 106 when the vehicle 104 is towing the towable object 106. The sensor data 110 may thus indicate how the towable object 106 normally moves and reacts during turning or cornering maneuvers that were taken at different travel speeds, at different turning angles, and/or in association with other differing variables. In some examples, the model training system 120 may receive other types of training data, such as similar historical sensor data 110 captured by sensors 114 on other vehicles and/or towable objects that are the same as, or similar to, the vehicle 104 and the towable object 106.

The model training system 120 may accordingly use the training data to train the machine learning model to predict how the towable object 106 is likely to respond during a turning or cornering maneuver. For instance, based upon factors such as how fast the vehicle 104 and the towable object 106 are traveling during a turning or cornering maneuver, based upon an angle at which the vehicle 104 is turning during a turning or cornering maneuver, based upon angles 910 between the vehicle axis 906 and the towable object axis 908 during a turning or cornering maneuver, and/or based other predictive factors identified during the training of the machine learning model, the machine learning model may predict values of the angle 910 at one or more points in tie throughout the duration of a turning or cornering maneuver, may predict a likelihood of the lane edge distance 904 decreasing to less than a threshold distance during the turning or cornering maneuver, and/or may predict other criteria that may be indicative of a safety issue during the turning or cornering maneuver.

Accordingly, the towing lane assist system 134 may output a safety alert during, or even before, a turning or cornering maneuver based upon a prediction generated by the machine learning model. As an example, GPS and/or mapping data may indicate that the vehicle 104 and the towable object 106 will be likely to perform a cornering maneuver due to an upcoming curve in the road. The machine learning model may predict that, based upon a current travel speed and an angle of the upcoming curve, the towable object 106 is likely to veer out of the current lane during the upcoming cornering maneuver. The towing lane assist system 134 may alert a corresponding safety alert and/or the chatbot 118 may suggest that the driver reduce the travel speed before the upcoming curve, such that the risk of the towable object 106 veering out of the travel lane during the cornering maneuver may be reduced.

The chatbot 118 may similarly generate and output corrective actions and/or content to express safety tips, customized to the driver and/or to the pair of the vehicle 104 and the towable object 106, based upon predictions generated by the machine learning model. For example, if the machine learning model predicts that the towable object 106 would react more safely during turning maneuvers if the driver takes turns at slower speeds and/or at wider angles, the chatbot 118 may proactively generate and output statements suggesting that the driver take future turns at slower speeds and/or at wider angles than in the past. In some examples, the chatbot 118 may also provide such safety tips, based upon predictions generated by the machine learning model, in response to user queries about how to increase safety during towing of the towable object 106.

### Exemplary Towing Backup Assist Environment

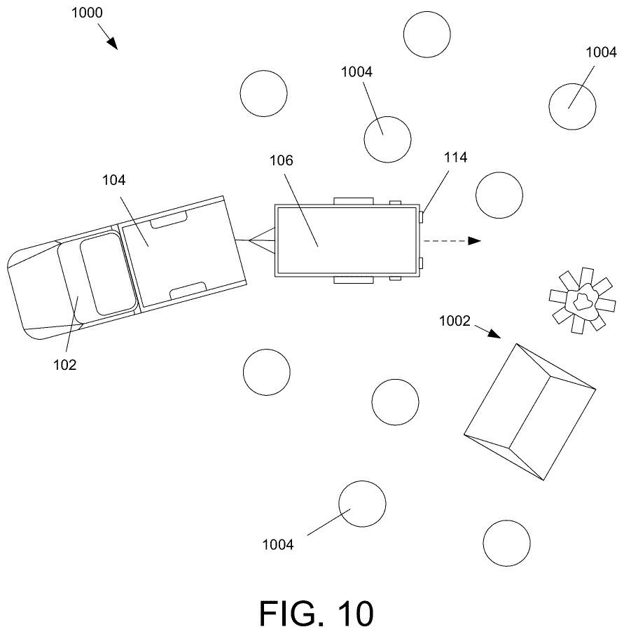

FIG. 10 shows an exemplary computer environment 1000 in which the smart towing assistant 102 may assist a driver of the vehicle 104 in association with backup maneuvers while the vehicle 104 is towing the towable object 106. As described above, a driver of the vehicle 104 may not have experience with towing. Accordingly, the driver may not be familiar with how the towable object 106 reacts to movements of the vehicle 104 as the vehicle 104 backs up. However, the smart towing assistant 102 may provide output that assists the driver in association with backing up the vehicle 104 and the towable object 106, such as providing various corrective actions discussed herein, including generating safety tips or suggestions presented via the chatbot 118 and/or safety alerts triggered by the towing lane assist system 134.

As shown in FIG. 10, a driver of the vehicle 104 may perform backup maneuvers while driving the vehicle 104 connected to the towable object 106, for instance to back up into a parking space or other location. For example, FIG. 10 shows a campsite 1002 near trees 1004, and the driver may want to back up the towable object 106 to a position close to the campsite 1002 so that the driver may unload camping supplies from the towable object 106 at the campsite 1002. The trees 1004 and/or other external objects present near the campsite 1002 may make such backup maneuvers relatively difficult and/or risky, for instance if the driver has relatively little experience with towing. For example, the towable object 106 may move, relative to the vehicle 104 and/or elements in the surrounding environment, in a way that the driver does not expect or does not anticipate during a backup maneuver. However, as described herein, the smart towing assistant 102 may assist the driver with such backup maneuvers during towing of the towable object 106.

As discussed above, sensors 114 that are permanently or temporarily on the towable object 106 may capture image data, proximity sensor data, distance measurements, and/or other types of sensor data 110 associated with the environment surrounding the towable object 106. Cameras or other sensors 114 on the vehicle 104, such as a backup camera of the vehicle 104, may in some examples also capture image data or other sensor data 110 associated with the environment surrounding the towable object 106.

Elements of the smart towing assistant 102, such as the chatbot 118 and/or the towing lane assist system 134, that execute via a computing system may receive the sensor data 110 captured by sensors 114 on the vehicle 104 and/or the towable object 106. The computing system may, for example, be an on-board computing system of the vehicle 104, an on-board computing system of the towable object 106, a user device, and/or another computing device, including computing devices equipped with generative AI. The elements of the smart towing assistant 102 may interface with a user interface that is part of, and/or is within, the vehicle 104, such that output of the smart towing assistant 102 may be perceived by a driver of the vehicle 104.

As an example, the smart towing assistant 102 may output a safety alert if the towing lane assist system 134 detects that, during a backup maneuver, the towable object 106 is at risk of colliding with a tree 1004 or other object. The towing lane assist system 134 may use image data, proximity sensor data, and/or other sensor data 110 to determine positions of trees 1004 and/or other objects within an environment surrounding the vehicle 104 and the towable object 106, as well as relative distances between the towable object 106 and such objects. The towing lane assist system 134 may also use sensor data 110 to determine a current or expected trajectory of the towable object 106 during a backup maneuver, and to determine corresponding positions and/or trajectories of trees 1004 and/or other objects within the surrounding environment.

In some situations, sensor data 110 captured by sensors 114 on the towable object 106 may indicate positions of trees 1004 and/or other objects behind the towable object 106, even if the towable object 106 itself obscures the driver's view of the objects and/or the objects are not detected based upon sensor data 110 captured by sensors of the vehicle 104. For example, the driver of the vehicle 104 may be unable to see a tree 1004 that behind the towable object 106 due to the presence of the towable object 106 between the driver and the tree 1004.

However, the towing lane assist system 134 may also measure or estimate distances from the towable object 106 to trees 1004 and/or other elements. The towing lane assist system 134 may compare determined distances between the towable object 106 and other elements within the surrounding environment against corresponding threshold distances. The towing lane assist system 134 may accordingly generate and output various corrective actions including those discussed herein, such as (i) generate and employ autonomous or semi-autonomous vehicle features; (ii) generate or adjust control decisions for autonomous or semi-autonomous systems and features; (iii) automatically engage autonomous or semi-autonomous features; (iv) recommend to a driver to engage autonomous or semi-autonomous features; and/or (v) generate one or more safety alerts perceivable by a driver of the vehicle 104 if, during a backup maneuver, such distances are less than corresponding thresholds or have been decreasing and trending towards such corresponding thresholds. Accordingly, the driver or an autonomous or semi-autonomous vehicle system may adjust movements of the vehicle 104 and/or the towable object 106 during a remainder of the backup maneuver to reduce the likelihood of a collision.

For the corrective actions discussed herein, the towing lane assist system 134 may also be configured to use sensor data 110 to determine a current or expected trajectory of the towable object 106 during a backup maneuver, and to determine corresponding positions and/or trajectories of other objects in the surrounding environment. As an example, the towing lane assist system 134 may use a series of images captured by cameras on the vehicle 104 and/or the towable object 106 to identify positions of trees 1004 relative to the towable object 106 during the backup maneuver, and/or a trajectory being taken by the vehicle 104 and/or the towable object 106 during the backup maneuver. The towing lane assist system 134 may compare the detected trajectory of the towable object 106 and/or positions of trees 1004 relative to the towable object 106 to determine if the towable object 106 has at least a threshold likelihood of colliding with a tree 1004 during the backup maneuver, and if so may generate and output various corrective actions discussed herein, such as generate a safety alert to that the driver may alter the travel trajectory of the vehicle 104 and/or the towable object 106 to reduce the chances of a collision; generate a recommendation to engage an autonomous or semi-autonomous feature; generate or adjust control decisions for autonomous or semi-autonomous features accordingly (i.e., to avoid or reduce the chances of collision); etc.

For some corrective actions and in some situations, the chatbot 118 may also provide the driver of the vehicle 104 with safety tips and/or other information associated with backup maneuvers. As an example, if the towing lane assist system 134 determines that a collision between the towable object 106 and a tree 1004 or other object is relatively likely due to a speed or angle at which the towable object 106 is traveling during a backup maneuver, the chatbot 118 may proactively generate and/or output natural language statements to inform the driver of the likely collision and/or to help the driver avoid the collision. For example, the chatbot 118 may provide (i) output indicating that a collision between the towable object 106 and a tree 1004 may be avoided if the driver turns the vehicle 104 to further to the left or right than a current angle, and thus guide the driver in how to control the vehicle 104 during a backup maneuver, and/or (ii) control decisions to autonomous or semi-autonomous features to avoid the tree and/or collision.

In some examples, elements of the smart towing assistant 102, such as the chatbot 118 and/or the towing lane assist system 134, may generate output based upon a machine learning model of backup maneuvers associated with the vehicle 104 and the towable object 106. The model training system 120 may generate such a machine learning model based upon training data indicating how the towable object 106 reacts to movements of the vehicle 104 during backup maneuvers. Accordingly, the smart towing assistant 102 may use the machine learning model to predict how the towable object 106 is likely to respond to movements of the vehicle 104 during current or future backup maneuvers.

The machine learning model of backup maneuvers may be based upon convolutional neural networks, fully-connected neural networks, other types of neural networks, nearest-neighbor algorithms, regression analysis, deep learning algorithms, GBMs, Random Forest algorithms, and/or other types of artificial intelligence or machine learning frameworks. The machine learning model can be trained on a set of training data, for instance using supervised machine learning, semi-supervised machine learning, or unsupervised machine learning.

The training data used to train the machine learning model may be based upon sensor data 110 associated with the vehicle 104 and the towable object 106 that has been captured over a period of time. The sensor data 110 may, for example, be historical data indicative of movements of the vehicle 104 and the towable object 106 when the vehicle 104 is towing the towable object 106. The sensor data 110 may thus indicate how the towable object 106 normally moves and reacts during backup maneuvers that were taken at different travel speeds, at different turning angles, and/or in association with other differing variables. In some examples, the model training system 120 may receive other types of training data, such as similar historical sensor data 110 captured by sensors 114 on other vehicles and/or towable objects that are the same as, or similar to, the vehicle 104 and the towable object 106.

The model training system 120 may accordingly use the training data to train the machine learning model to predict how the towable object 106 is likely to respond during a backup maneuver. For instance, based upon factors such as how fast the vehicle 104 and the towable object 106 are traveling during a backup maneuver, based upon an angle at which the vehicle 104 is turning during a backup maneuver, angles 910 between the vehicle axis 906 and the towable object axis 908 during a backup maneuver, and/or based upon other predictive factors identified during the training of the machine learning model, the machine learning model may predict how the towable object 106 is likely to move during a backup maneuver.

Accordingly, the towing lane assist system 134 may output a safety alert during a backup maneuver based upon a prediction generated by the machine learning model. As an example, if the driver begins to move the vehicle 104 in a certain direction and/or at a certain speed during a backup maneuver, the machine leaning model may predict that continuing to back up at that direction and/or speed is likely to cause the towable object 106 to collide with a tree 1004 or other object detected in the surrounding environment. The towing lane assist system 134 may alert a corresponding safety alert, such that the risk of a collision involving the towable object 106 during the backup maneuver may be reduced.

The chatbot 118 may similarly generate and output content to express safety tips, customized to the driver and/or to the pair of the vehicle 104 and the towable object 106, based upon predictions generated by the machine learning model. For example, the machine learning model may predict that, based upon a current angle at which the vehicle 104 is backing up, and a resulting angle at which the towable object 106 is backing up, a collision between the towable object 106 and a nearby tree 1004 detected in the surrounding environment is relatively likely. However, the machine learning model may predict that if the angle at which the vehicle 104 is backing up were to be changed by a particular amount, the resulting angle at which the towable object 106 is backing up would also change by an amount sufficient to avoid the collision between the towable object 106 and the nearby tree 1004.

The chatbot 118 may accordingly proactively generate and output statements suggesting that the driver alter the angle at which the vehicle 104 is backing up by the amount that the machine learning model predicts would avoid the collision with the tree 1004. In some examples, the chatbot 118 may also provide safety tips, based upon predictions generated by the machine learning model, in response to user queries about how to increase safety during backup maneuvers while towing the towable object 106.

In one aspect, a computer-implemented method for providing driving assistance may be provided. The method may include (1) receiving, by a computing system comprising a processor, sensor data captured by at least one sensor in association with a maneuver performed by a vehicle during towing of a towable object by the vehicle. The at least one sensor may be mounted on the vehicle or the towable object. The method may also include (2) detecting, by the computing system, and based at least in part on the sensor data, a safety issue associated with the maneuver; and/or (3) generating, by the computing system, a corrective action, such as (i) outputting an alert a driver of the vehicle of the safety issue; (ii) adjusting operation of autonomous or semi-autonomous feature or system; (iii) determining control decisions for one or more autonomous or semi-autonomous features; and/or (iv) engaging or recommending to engage an autonomous or semi-autonomous feature or system to reduce or prevent collision, or otherwise alleviate or mitigate the safety issue. The method may include additional, less, or alternate actions, including those discussed elsewhere.

For instance, the maneuver may be a turning or cornering maneuver, and the safety issue may be associated with a likelihood of the towable object (a) veering outside a current travel lane during the turning or cornering maneuver, and/or (b) colliding with an external object during the turning or cornering maneuver. Additionally or alternatively, the maneuver may be a backup maneuver, and the safety issue is related to veering outside a travel lane or collision during the backup maneuver.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for providing towing-related information via a chatbot, the method comprising:
providing, by a computing system comprising one or more processors, a smart towing assistant comprising the chatbot, wherein the chatbot is trained, based upon a training dataset, to engage in a conversation with a user in association with towing of a towable object by a vehicle;
receiving, by the computing system, and via the chatbot during the conversation, user input comprising natural language input;
generating, by the computing system, and via the chatbot, output based at least in part on the user input, wherein the output comprises natural language output that expresses the towing-related information; and
presenting, by the computing system, and via the chatbot, the output during the conversation.

2. The computer-implemented method of claim 1, wherein the chatbot is a generative pre-trained transformer (GPT) model trained on the training dataset.

3. The computer-implemented method of claim 1, wherein the training dataset comprises at least one of:
manufacturer data indicating attributes of vehicles and towable objects,
towing safety information approved by an insurance company, or
insurance policy information associated with a set of insurance policies provided by the insurance company.

4. The computer-implemented method of claim 1, further comprising:
determining, by the computing system, an identity of at least one of the vehicle or the towable object,
wherein the chatbot generates the output based at least in part on the identity of the at least one of the vehicle or the towable object.

5. The computer-implemented method of claim 4, wherein the output expresses towing- related safety information based at least in part on attributes of the at least one of the vehicle or the towable object indicated by manufacturer data.

6. The computer-implemented method of claim 4, wherein the computing system determines the identity of at least one of the vehicle or the towable object based upon at least one of:
a user-provided description,
image analysis of a user-provided photograph of the at least one of the vehicle or the towable object, or
insurance policy information associated with the at least one of the vehicle or the towable object.

7. The computer-implemented method of claim 1, further comprising:
estimating, by the computing system, a towing experience level of the user based at least in part on the user input received during the conversation,
wherein the chatbot generates the output based at least in part on the towing experience level of the user.

8. The computer-implemented method of claim 1, wherein the output expresses towing insurance coverage information indicating whether an insurance policy covers the towing of the towable object by the vehicle.

9. The computer-implemented method of claim 1, further comprising:
determining, by the computing system, that the user input requests a change to an insurance policy to adjust towing insurance coverage; and
initiating, by the computing system, the change to the insurance policy based upon the user input.

10. The computer-implemented method of claim 1, further comprising:
receiving, by the computing system, sensor data associated with the towing of the towable object by the vehicle;
detecting, by the computing system, an instance of towing activity based upon the sensor data; and
providing, by the computing system, towing usage data associated with the instance of towing activity to a usage-based insurance system,
wherein the usage-based insurance system is configured to determine a billing amount for usage-based towing insurance based at least in part on the towing usage data.

11. The computer-implemented method of claim 1, further comprising:
receiving, by the computing system, image data indicative of an environment surrounding the towable object during the towing of the towable object by the vehicle;
determining, by the computing system, and based upon the image data, at least one of:
a distance between the towable object and lane markings decreasing below a threshold distance, or
a trajectory of the towable object having at least a threshold likelihood of causing the towable object to collide with another object; and
outputting, by the computing system, an alert that indicates a towing-related safety issue to the user or a driver of the vehicle.

12. A computing system configured to provide towing-related information via a chatbot, the computing system comprising:
one or more processors, and
memory storing computer-executable instructions that, when executed by the one or more processors, cause the one or more processors to:
receive, via the chatbot, and during a conversation associated with towing of a towable object by a vehicle, user input comprising natural language input, wherein the chatbot is trained on a training dataset;
generate, via the chatbot, output based at least in part on the user input, wherein the output comprises natural language output that expresses the towing-related information; and
present, via the chatbot, the output during the conversation.

13. The computing system of claim 12, wherein:
the computing system is an on-board computing system of the vehicle,
the chatbot receives the user input as at least one of text input or audio input via one or more input devices of the vehicle, and
the chatbot presents the output as at least one of text output or audio output via at least one of a dashboard screen, speakers, or other output devices of the vehicle.

14. The computing system of claim 12, wherein the computing system is a user device.

15. The computing system of claim 14, wherein:
the user device connects to a dashboard system of the vehicle, and
the chatbot interacts with a user via input devices and output devices of the vehicle.

16. A computer-implemented smart towing assistant configured to provide towing assistance associated with a vehicle, comprising:
a chatbot trained, based upon a training dataset, to engage in a conversation with a user in association with towing of a towable object by the vehicle;
a towing detector configured to detect, based upon sensor data associated with at least one of the vehicle or the towable object, towing activity associated with the towing of the towable object by the vehicle; and
a towing lane assist system configured to:
detect, based upon the sensor data, a safety issue associated with the towing of the towable object by the vehicle, and
output an alert associated with the safety issue.

17. The computer-implemented smart towing assistant of claim 16, wherein the chatbot is configured to engage in the conversation by:
receiving user input comprising natural language input;
generating output based at least in part on the user input, wherein the output comprises natural language output that expresses towing-related information; and
presenting the output during the conversation.

18. The computer-implemented smart towing assistant of claim 16, wherein the chatbot is configured to proactively steer the conversation to one or more towing-related topics.

19. The computer-implemented smart towing assistant of claim 16, wherein:
the towing detector is further configured to provide towing usage data, associated with the towing activity, to a usage-based insurance system, and
the usage-based insurance system is configured to determine a billing amount for usage-based towing insurance based at least in part on the towing usage data.

20. The computer-implemented smart towing assistant of claim 16, wherein:
the sensor data comprises image data indicative of an environment surrounding the towable object, and
the towing lane assist system detects the safety issue by determining, based upon the image data, at least one of:
a distance between the towable object and lane markings decreasing below a threshold distance, or
a trajectory of the towable object having at least a threshold likelihood of causing the towable object to collide with another object.
